(19) United States
(12) Patent Application Publication
(10) Pub. No.: US 2025/0380696 A1
(43) Pub. Date: Dec. 18, 2025

(54) METHOD FOR CONTROLLING UNDESIRED PLANTS AND PROMOTING GROWTH OF USEFUL PLANTS

(71) Applicant: ISHIHARA SANGYO KAISHA, LTD., Osaka (JP)

(72) Inventors: Taketo SUGANUMA, Osaka (JP); Shota FUKUDA, Osaka (JP)

(73) Assignee: ISHIHARA SANGYO KAISHA, LTD., Osaka (JP)

(21) Appl. No.: 18/881,915

(22) PCT Filed: Jul. 11, 2023
(86) PCT No.: PCT/JP2023/025527

§ 371 Date: Jan. 7, 2025

(30) Foreign Application Priority Data
Jul. 29, 2022 (JP) 2022-121363

(51) Int. Cl. A01N 43/54; A01N 37/20; A01N 37/22; A01N 43/10; A01N 43/707; A01N 43/80; A01N 47/12; A01P 13/02; A01P 21/00

(52) U.S. Cl. CPC A01N 43/54; A01N 37/20; A01N 37/22; A01N 43/10; A01N 43/707; A01N 43/80; A01N 47/12; A01P 13/02; A01P 21/00

(57) ABSTRACT

To provide a method for controlling undesired plants and promoting growth of useful plants, and a composition.

A method for controlling undesired plants and promoting growth of useful plants, which comprises applying an effective amount of tiafenacil (a1) and an effective amount of at least one herbicidal compound (a2) selected from the compound group A described in the specification, to the undesired plants, to a place where the undesired plants grow, or to a place where the useful plants are cultivated.

### TECHNICAL FIELD

The present invention relates to a method for controlling undesired plants and promoting growth of useful plants, which comprises applying an effective amount of tiafenacil (a1) and an effective amount of at least one herbicidal compound (a2) selected from the following compound group A, to the undesired plants, to a place where the undesired plants grow, or to a place where the useful plants are cultivated.

### BACKGROUND ART

Patent Document 1 discloses a herbicidal composition comprising, as active ingredients, a uracil compound represented by a specific formula and other herbicidally active compound.

Non-Patent Document 1 discloses herbicidal effects of a mixture of tiafenacil and metribuzin on glyphosate-resistant horseweed.

Patent Document 2 discloses, in Table 1-17, an agricultural composition comprising flumioxazin and tiafenacil, in a weight ratio of tiafenacil/flumioxazin being 1/1,000 or less.

However, these documents do not specifically disclose the after-described method for controlling undesired plants and promoting growth of useful plants, of the present invention.

Patent Document 3 discloses a lawn growth promoter comprising a compound having PPO inhibitory activity, a compound having VLCFA synthesis inhibitory activity, or a combination thereof, and a method for promoting growth of lawn. However, Patent Document 3 does not disclose tiafenacil.

In Non-Patent Document 2 and Non-Patent Document 3, growth control or effects on the height of plant by single use of tiafenacil on useful plants beans and peppermint, are confirmed, however, these documents do not describe effects to promote the growth of useful plants by use of tiafenacil and other herbicidal compound in combination.

### PRIOR ART DOCUMENTS

### Patent Documents

Patent Document 1: WO2013/154396

Patent Document 2: JP-A-2020-15768

Patent Document 3: JP-A-2016-88913

### Non-Patent Documents

Non-Patent Document 1: Weed Technology, 35, 817-823

Non-Patent Document 2: Weed Technology, 35, 991-994

Non-Patent Document 3: Weed Technology, 36, 729-732

### DISCLOSURE OF INVENTION

### Technical Problem

At present, to control various undesired plants, a mixture of various herbicides and use of herbicides in combination are employed, however, some of combinations of herbicides have such drawbacks that sufficient effects to control undesired plants may not necessarily be obtained, ingredients in the combination weaken each other, and further, the combination may cause damages to the useful plants and impair the growth or the quality of the useful plants.

Under these circumstances, the object of the present invention is to provide a method for controlling undesired plants and promoting growth of useful plants.

### Solution to Problem

The present invention provides a method for controlling undesired plants and promoting growth of useful plants, which comprises applying an effective amount of tiafenacil (a1) and an effective amount of at least one herbicidal compound (a2) selected from the following compound group A, to the undesired plants, to a place where the undesired plants grow, or to a place where the useful plants are cultivated (hereinafter sometimes referred to as the method of the present invention);
compound group A: herbicidal compounds S-metolachlor, metribuzin, pyroxasulfone, pethoxamid, tri-allate and dimethenamid-P.

The present invention further provides an agricultural composition comprising as active ingredients tiafenacil (a1) and at least one herbicidal compound (a2) selected from the above compound group A, in a mixing weight ratio of (a1) to (a2) of from 1:0.8 to 1:1000 (hereinafter sometimes referred to as the composition of the present invention).

The present invention still further provides a combination of tiafenacil (a1) and at least one herbicidal compound (a2) selected from the above compound group A as active ingredients, in a mixing weight ratio of (a1) to (a2) of from 1:0.8 to 1:1000. In this specification, the composition of the present invention includes the above combination.

### Advantageous Effects of Invention

The composition of the present invention has excellent herbicidal effects against undesired plants, which are unexpected from single use of (a1) and (a2), and has effects to promote growth of useful plants. As a result, the dose of tiafenacil (a1) and/or the dose of at least one herbicidal compound (a2) selected from the following compound group A can be reduced, and thus the present invention is useful in actual use.

### DESCRIPTION OF EMBODIMENTS

According to the present invention, undesired plants can be controlled by applying an effective amount of tiafenacil (a1) and an effective amount of at least one herbicidal compound (a2) selected from the compound group A to the undesired plants, to a place where the undesired plants grow, or to a place where useful plants are cultivated. Further, undesired plants can be controlled by applying an effective amount of the composition of the present invention to the undesired plants, to a place where the undesired plants grow, or to a place where useful plants are cultivated.

According to the present invention, growth of useful plants can be promoted by applying an effective amount of tiafenacil (a1) and an effective amount of at least one herbicidal compound (a2) selected from the compound group A to undesired plants, to a place where the undesired plants grow, or to a place where the useful plants are cultivated. Further, growth of useful plants can be promoted by applying an effective amount of the composition of the present invention to undesired plants, to a place where the undesired plants grow, or to a place where the useful plants are cultivated.

For promotion of growth of useful plants, an effective amount of tiafenacil (a1), the herbicidal compound (a2) or the composition of the present invention may be applied to undesired plants, to a place where the undesired plants grow, or to a place where the useful plants are cultivated, before the start of cultivation of the useful plants, for example before sowing the seeds of the useful plants or before planting the seedlings of the useful plants. The growth of the useful plants which started growing by sowing the seeds or by planting the seedlings after the application is promoted.

The composition of the present invention contains tiafenacil (a1) and at least one herbicidal compound (a2) selected from the following compound group A as active ingredients.

The compound group A is a group consisting of the herbicidal compounds (a2) S-metolachlor, metribuzin, pyroxasulfone, pethoxamid, tri-allate and dimethenamid-P. Among them, the herbicidal compound (a2) is preferably S-metolachlor, metribuzin, pyroxasulfone or tri-allate, more preferably S-metolachlor or metribuzin, or, more preferably S-metolachlor, pyroxasulfone or tri-allate. The herbicidal compound (a2) is further preferably S-metolachlor or pyroxasulfone, or, further preferably S-metolachlor or tri-allate, and particularly preferably S-metolachlor.

Tiafenacil (a1) and the herbicidal compound (a2) may sometimes have their salts, alkyl esters, hydrates, different crystal forms, various structural isomers, etc., and they are of course included in the present invention.

The mixing weight ratio of tiafenacil (a1) to the herbicidal compound (a2) in the present invention cannot generally be defined, as it varies depending upon various conditions such as the type of the formulation of the active ingredient mixed, the weather conditions, and the type, growth state, etc. of undesired plants to be controlled. However, the mixing weight ratio of (a1): (a2) is usually from 1:0.8 to 1:1000, preferably from 1:1.2 to 1:200. In a case where the herbicidal compound (a2) is S-metolachlor, the mixing weight ratio of (a1): (a2) is more preferably from 1:1.2 to 1:180, further preferably from 1:1.2 to 1:150, particularly preferably from 1:1.2 to 1:120. In a case where the herbicidal compound (a2) is metribuzin, the mixing weight ratio of (a1): (a2) is more preferably from 1:1.2 to 1:190, further preferably from 1:1.2 to 1:180, still more preferably from 1:1.2 to 1:160, particularly preferably from 1:1.5 to 1:176, more particularly preferably from 1:1.5 to 1:130, still more particularly preferably from 1:1.5 to 1:88. In a case where the herbicidal compound (a2) is pyroxasulfone, the mixing weight ratio of (a1): (a2) is more preferably from 1:1.2 to 1:160, further preferably from 1:1.2 to 1:120, still more preferably from 1:1.2 to 1:80, particularly preferably from 1:1.2 to 1:70, more particularly preferably from 1:1.2 to 1:60, still more particularly preferably from 1:1.2 to 1:40. In a case where the herbicidal compound (a2) is tri-allate, the mixing weight ratio of (a1): (a2) is more preferably from 1:7 to 1:200, further preferably from 1:8 to 1:200, particularly preferably from 1:12 to 1:200. In a case where the herbicidal compound (a2) is pethoxamid, the mixing weight ratio of (a1): (a2) is more preferably from 1:8 to 1:200, further preferably from 1:12 to 1:160, particularly preferably from 1:15 to 1:120. In a case where the herbicidal compound (a2) is dimethenamid-P, the mixing weight ratio of (a1): (a2) is more preferably from 1:6 to 1:200, further preferably from 1:8 to 1:160, particularly preferably from 1:9.6 to 1:120.

In the method of the present invention, the doses of tiafenacil (a1) and the herbicidal compound (a2) cannot generally be defined, as they vary depending upon various conditions such as the type of the formulation of the active ingredient mixed, the weather conditions, and the type, growth state, etc. of undesired plants to be controlled. However, the dose of (a1) is usually from 0.01 to 400 g, preferably from 0.05 to 300 g, more preferably from 0.1 to 200 g, further preferably from 0.5 to 100 g, particularly preferably from 1 to 100 g, per hectare, and the dose of (a2) is usually from 0.1 to 5000 g, preferably from 1 to 4000 g, per hectare. In a case where the herbicidal compound (a2) is S-metolachlor, its dose is more preferably from 10 to 3000 g, further preferably from 25 to 2000 g, particularly preferably from 250 to 1500 g, per hectare. In a case where the herbicidal compound (a2) is metribuzin, its dose is more preferably from 10 to 3000 g, further preferably from 25 to 2000 g, particularly preferably from 50 to 1500 g, per hectare. In a case where the herbicidal compound (a2) is pyroxasulfone, its dose is more preferably from 10 to 1000 g, further preferably from 25 to 500 g, particularly preferably from 50 to 300 g, per hectare. In a case where the herbicidal compound (a2) is tri-allate, its dose is more preferably from 10 to 3700 g, further preferably from 25 to 3300 g, particularly preferably from 500 to 3000 g, per hectare. In a case where the herbicidal compound (a2) is pethoxamid, its dose is more preferably from 10 to 3000 g, further preferably from 25 to 3000 g, particularly preferably from 500 to 2000 g, per hectare. In a case where the herbicidal compound (a2) is dimethenamid-P, its dose is more preferably from 10 to 3000 g, further preferably from 25 to 3000 g, particularly preferably from 300 to 2000 g, per hectare.

The composition of the present invention, applied to undesired plants, to a place where the undesired plants grow or to a place where useful plants are cultivated, exhibits excellent controlling effects on the undesired plants and promotes growth of the useful plants. The place includes various non-agricultural fields such as parking area, cemeteries, residential lands, embankments, gardens, parks, forests, roads, farm roads, grounds and factory site, and agricultural fields such as crop plant fields, orchards, mulberry fields and lawns. Particularly, the composition of the present invention is preferably applied to an agricultural field or to a place where useful plants are to be cultivated in future. The cultivation means a series of actions to produce harvest of useful plants, starting from sowing the seed, planting the seed, or planting vegetative reproduction organ of the useful plants. In addition, the said seed means seeds or seedlings.

The application method of the composition of the present invention is properly selected from soil treatment, foliar treatment, water treatment, and the like. The application time of the composition of the present invention is properly selected from after harvest of the useful plants to before next sowing, and after sowing to before budding of the useful plants.

In the case of the soil treatment, the dose of (a1) is preferably 0.01 to 400 g, more preferably 0.05 to 300 g, per hectare, and the dose of (a2) is preferably 0.1 to 5000 g, more preferably 1 to 4000 g, per hectare. In the case of the foliar treatment, the dose of (a1) is preferably 0.01 to 400 g, more preferably 0.05 to 300 g, per hectare, and the dose of (a2) is preferably 0.1 to 5000 g, more preferably 1 to 4000 g, per hectare. In the case of the water treatment, the dose of (a1) is preferably 0.01 to 400 g, more preferably 0.05 to 300 g, per hectare, and the dose of (a2) is preferably 0.1 to 5000 g, more preferably 1 to 4000 g, per hectare.

The soil treatment is a method of applying the composition of the present invention to soils before budding of useful plants or undesired plants. By applying the composition of the present invention by the soil treatment, a layer treated with the composition of the present invention is formed on the soil surface, and effects of the composition of the present invention are exhibited to each plant.

The foliar treatment is a method of applying the composition of the present invention, after budding of useful plants or undesired plants, to foliage of the plants. By application of the composition of the present invention by the foliar treatment, the ingredients are absorbed from or brought into contact with the foliage, and effects of the composition of the present invention are exhibited to each plant.

The water treatment is a method of applying the composition of the present invention to a flooded paddy field where useful plants are cultivated or undesired plants grow. By applying the composition of the present invention by the water treatment, effects of the composition of the present invention are exhibited to each plant.

In each of the above treatments, the composition of the present invention is diluted with e.g. water to a predetermined concentration and is sprayed by a sprayer over undesired plants, a place where undesired plants grow, or a place where useful plants are cultivated. Further, a flying device such as an automatic helicopter or a drone, a power spreader or a boom sprayer may be used.

In each of the above treatments, the dose of the composition of the present invention is such that the above mixing ratio of tiafenacil (a1) to the herbicidal compound (a2) or the doses of the respective ingredients are applied.

“To promote growth of useful plants” in the present invention (hereinafter sometimes referred to as “growth promotion”) means an increase of the weight of the plant, an increase of the area of leaves, an increase of the number of healthy leaves, an increase of the height of the plant, growth of roots or an increase of the density of roots, an increase of the number or the weight of seeds or fruits, or an increase of the number of flowers or the number of fruits. The composition of the present invention is suitable particularly for an increase of the weight of the plant and/or an increase of the weight of seeds.

The growth promotion may be quantified and evaluated by the following method.

### (1) Evaluation by Weight of Plant

The above-ground part of each useful plant is cut and its weight is measured to obtain the raw weight, or the cut sample is dried and its weight is measured to obtain the dry weight.

### (2) Evaluation by Area of Leaves

Leaves of each useful plant are collected, and the total area of leaves is obtained by a leaf area meter.

### (3) Evaluation by Number of Healthy Leaves

The number of healthy leaves of each useful plant is counted.

### (4) Evaluation by Height of Plant

The above-ground part of each useful plant is kept upright, and the height from the ground surface to the highest position is measured.

### (5) Evaluation by Growth of Roots or Density of Roots

The roots of each useful plant are dug up and their weight is measured to obtain the raw weight, or the obtained sample roots are dried and their weight is measured to obtain the dry weight.

### (6) Evaluation by Number or Weight of Seeds or Fruits

The seeds or fruits of each useful plant are collected, and their number is counted, or their weight is measured to obtain the total weight or the average.

(7) Evaluation by Number of Flowers or Number of Fruits The number of flowers or the number of fruits of each useful plant is counted.

The composition of the present invention can be used to control undesired plants or inhibit their growth, for example, Poaceae weeds such as barnyardgrass (Echinochloa crus-galli, Echinochloa oryzicola), southern crabgrass (Digitaria ciliaris, Digitaria adscendens), large carbgrass (Digitaria sanguinalis), smooth crabgrass (Digitaria ischaemum), East Indian crabgrass (Digitaria microbachne), Jamaican crabgrass (Digitaria horizontalis), green foxtail (Setaria viridis), giant foxtail (Setaria faberi), yellow foxtail (Setaria lutescens), goosegrass (Eleusine indica), wild oat (Avena fatua), johnsongrass (Sorghum halepense), quackgrass (Agropyron repens), hairy signalgrass (Urochloa villosa), alexandergrass (Brachiaria plantaginea), guineagrass (Panicum maximum), paragrass (Panicum purpurascens), Chinese sprangletop (Leptochloa chinensis), red sprangletop (Leptochloa panicea), annual bluegrass (Poa annua), shortawn foxtail (Alopecurus aequalis), blackgrass (Alopecurus myosuroides), cholorado bluestem (Agropyron tsukushiense), broadleaf signalgrass (Brachiaria platyphylla), southern sandbur (Cenchrus echinatus), Italian ryegrass (Lolium multiflorum), bermudagrass (Cynodon dactylon), violet crabgrass (Digitaria violascens), knotgrass (Paspalum distichum), little quakinggrass (Briza minor), sweet vernalgrass (Anthoxanthum odoratum), fall panicum (Panicum dichotomiflorum), shattercane (Sorghum bicolor) and American sloughgrass (Beckmannia syzigachne); Cyperaceae weeds such as rice flatsedge (Cyperus iria), purple nutsedge (Cyperus rotundus), yellow nutsedge (Cyperus esculentus), tidal-marsh flatsedge (Cyperus serotinus), smallflower umbrella sedge (Cyperus difformis), needle spikerush (Eleocharis acicularis), water chestnut (Eleocharis kuroguwai), green kyllinga (Kyllinga brevifolia var. leiolepis), Schoenoplectus nipponicus, cosmopolitan bulrush (Bolboschoenus koshevnikovii), amur cyperus (Cyperus microiria) and rock bulrush (Schoenoplectus juncoides);

Alismataceae weeds such as Japanese ribbon waparo (Sagittaria pygmaea), arrow-head (Sagittaria trifolia) and channelled waterplantain (Alisma canaliculatum);

Pontederiaceae weeds such as heartshape false pickerelweed (Monochoria vaginalis) and korsakow monochoria (Monochoria korsakowii);

Lythraceae weeds such as Indian toothcup (Rotala indica) and jerry-jerry (Ammannia multiflora);

Elatinaceae weeds such as long stem water-wort (Elatine triandra);

Malvaceae weeds such as velvetleaf (Abutilon theophrasti), prickly sida (Sida spinosa), volunteer cotton (Gossypium hirsutum), common mallow (Malva neglecta), little mallow (Malva parviflora) and venice mallow (Hibiscus trionum);

Asteraceae weeds such as common cocklebur (Xanthium strumarium), common ragweed (Ambrosia artemisiifolia), thistle (Breea setosa), hairy galinsoga (Galinsoga ciliata), wild chamomile (Matricaria chamomilla), scentless chamomile (Tripleurospermum maritimum), mayweed chamomile (Anthemis cotula), hairy fleabane (Conyza bonariensis), tall fleabane (Conyza sumatrensis), tall goldenrod (Solidago altissima), prickly lettuce (Lactuca serriola), philadelphia fleabane (Erigeron philadelphicus), annual fleabane (Erigeron annuus), common groundsel (Senecio vulgaris), giant ragweed (Ambrosia trifida), horseweed (Conyza canadensis), dandelion (Taraxacum officinale), devils beggarticks (Bidens frondosa), beggar ticks (Bidens biternata), hairy beggarticks (Bidens pilosa), narrow-leaf hawksbeard (crepis tectorum), santa maria feverfew (Parthenium hysterophorus), spiny sowthistle (Sonchus asper), annual sowthistle (Sonchus oleraceus), volunteer common sunflower (Helianthus annuus), Canada thistle (Cirsium arvense) and bristly starbur (Acanthospermum hispidum);

Solanaceae weeds such as black nightshade (Solanum nigrum), jimsonweed (Datura stramonium), cutleaf groundcherry (Physalis angulate var. angulata), horsenettle (Solanum carolinense), cut-leaf nightshade (Solanum triflorum), eastern black nightshade (Solanum ptycanthum) and hairy nightshade (Solanum sarrachoides);

Amaranthaceae weeds such as slender amaranth (Amaranthus viridis), redroot pigweed (Amaranthus retroflexus), livid amaranth (Amaranthus blitum), Japanese chaff-flower (Achyranthes bidentata var. japonica), palmer amaranth (Amaranthus palmeri), kochia (Bassia scoparia), smooth pigweed (Amaranthus hybridus), slender amaranth (Amaranthus viridis), powell's amaranth (Amaranthus powellii), spiny amaranth (Amaranthus spinosus), clammy goosefoot (Dysphania pumilio), common lambsquarters (Chenopodium album), fat hen (Chenopodium album var. centrorubrum), narrow-leaf goosefoot (Chenopodium pratericola), procumbent pigweed (Amaranthus blitoides), Russian thistle (Salsola sp.) and waterhemp (Amaranthus tuberculatus);

Polygonaceae wees such as pale smartweed (Polygonum lapathifolium), ladysthumb (Polygonum persicaria), wild buckwheat (Polygonum convolvulus), knotweed (Polygonum aviculare), pale smartweed (Persicaria lapathifolia var. lapathifolia), japanese knotweed (Fallopia japonica), oriental lady's thumb (Persicaria longiseta), sheep sorrel (Rumex acetosella subsp. pyrenaicus), thunberg knotweed (Persicaria thunbergii), nepalese smartweed (Persicaria nepalensis), Japanese dock (Rumex japonicus) and Pennsylvania smartweed (Persicaria pensylvanica);

Brassicaceae weeds such as flexuous bittercress (Cardamine flexuosa), shepherd's-purse (Capsella bursa-pastoris), Indian mustard (Brassica juncea), variableleaf yellowcress (Rorippa indica), marsh yellowcress (Rorippa palustris), volunteer canola (Brassica spp.), smallseed falseflax (Camelina microcarpa), flixweed (Descurainia sophia), black mustard (Brassica nigra), tumble mustard (Sisymbrium altissimum), wild mustard (Sinapis arvensis), field pennycress (Thlaspi arvense), London rocket (Sisymbrium irio) and pinnate tansymustard (Descurainia pinnata);

Convolvulaceae weeds such as tall morningglory (Ipomoea purpurea), field bindweed (Calystegia arvensis), ivyleaf morningglory (Ipomoea hederacea), entireleaf morningglory (Ipomoea hederacea var. integriuscula), palmleaf morningglory (Ipomoea wrightii) and pitted morningglory (Ipomoea lacunosa);

Portulacaceae weeds such as common purslane (Portulaca oleracea);

Fabaceae weeds such as sicklepod (Cassia obtusifolia), red clover (Trifolium pratense), narrowleaf vetch (Vicia sativa subsp. nigra var. segetalis), white clover (Trifolium repens), tiny vetch (Vicia hirsuta), volunteer alfalfa (Medicago sativa), black medic (Medicago lupulina), common lespedeza (Kummerowia striata), suckling clover (Trifolium dubium), bird's foot trefoil (Lotus comiculatus var. japonicus), Florida beggarweed (Desmodium tortuosum) and hemp sesbania (Sesbania herbacea);

Caryophyllaceae weeds such as common chickweed (Stellaria media), water chickweed (Stellaria aquatica), sticky chickweed (Cerastium glomeratum), Japanese pearlwort (Sagina japonica), bog chickweed, bog starwort (Stellaria uliginosa var. undulata), pot marigold (Calendula officinalis) and cowcockle (Vaccaria hispanica);

Lamiaceae weeds such as henbit (Lamium amplexicaule) and purple deadnettle (Lamium purpureum);

Rubiaceae weeds such as catchweed (Galium spurium), catchweed bedstraw (Galium aparine) and Florida pusley (Richardia scabra);

Euphorbiaceae weeds such as threeseeded copperleaf (Acalypha australis), spotted spurge (Euphorbia maculata), texasweed (Caperonia palustris) and Virginia copperleaf (Acalypha virginica);

Commelinaceae weeds such as Asiatic dayflower (Commelina communis);

Linderniaceae weeds such as common false pimpernel (Lindernia procumbens), false pimpernel (Lindernia dubia subsp. major), false pimpernel (Lindernia dubia subsp. dubia) and (Lindernia micrantha);

Plantaginaceae weeds such as dopatrium (Dopatrium junceum), Gratiola japonica), Asiatic plantain (Plantago asiatica), persian speedwell (Veronica persica) and corn speedwell (Veronica arvensis);

Molluginaceae weeds such as Carpetweed (Mollugo verticillata);

Onagraceae weeds such as cutleaf eveningprimrose (Oenothera laciniata) and American willowherb (Epilobium ciliatum);

Geraniaceae weeds such as redstem filaree (Erodium cicutarium);

Apiaceae weeds such as poison-hemlock (Conium maculatum);

Urticaceae weeds such as burning nettle (Urtica urens);

Zygophyllaceae weeds such as puncturevine (Tribulus terrestris); and

Cucurbitaceae weeds such as burcucumber (Sicyos angulatus).

The composition of the present invention can be suitably used to control undesired plants or inhibit their growth, for example, Poaceae weeds such as barnyardgrass (Echinochloa crus-galli, Echinochloa oryzicola), southern crabgrass (Digitaria ciliaris, Digitaria adscendens), large carbgrass (Digitaria sanguinalis), smooth crabgrass (Digitaria ischaemum), East Indian crabgrass (Digitaria microbachne), Jamaican crabgrass (Digitaria horizontalis), giant foxtail (Setaria faberi), goosegrass (Eleusine indica), wild oat (Avena fatua), Chinese sprangletop (Leptochloa chinensis), annual bluegrass (Poa annua), shortawn foxtail (Alopecurus aequalis), blackgrass (Alopecurus myosuroides), italian ryegrass (Lolium multiflorum), violet crabgrass (Digitaria violascens), fall panicum (Panicum dichotomiflorum) and American sloughgrass (Beckmannia syzigachne);

Cyperaceae weeds such as purple nutsedge (Cyperus rotundus), yellow nutsedge (Cyperus esculentus) and green kyllinga (Kyllinga brevifolia var. leiolepis);

Malvaceae weeds such as velvetleaf (Abutilon theophrasti);

Asteraceae weeds such as common ragweed (Ambrosia artemisiifolia), hairy galinsoga (Galinsoga ciliata), tall fleabane (Conyza sumatrensis), philadelphia fleabane (Erigeron philadelphicus) and dandelion (Taraxacum officinale);

Solanaceae weeds such as black nightshade (Solanum nigrum);

Amaranthaceae weeds such as redroot pigweed (Amaranthus retroflexus), powell's amaranth (Amaranthus powellii), livid amaranth (Amaranthus blitum), palmer amaranth (Amaranthus palmeri), smooth pigweed (Amaranthus hybridus), slender amaranth (Amaranthus viridis), spiny amaranth (Amaranthus spinosus), kochia (Bassia scoparia), common lambsquarters (Chenopodium album), fat hen (Chenopodium album var. centrorubrum) and waterhemp (Amaranthus tuberculatus);

Polygonaceae weeds such as pale smartweed (Polygonum lapathifolium), pale smartweed (Persicaria lapathifolia var. lapathifolia), Oriental lady's thumb (Persicaria longiseta) and nepalese smartweed (Persicaria nepalensis);

Brassicaceae weeds such as flexuous bittercress (Cardamine flexuosa), shepherd's-purse (Capsella bursa-pastoris) and marsh yellowcress (Rorippa palustris);

Convolvulaceae weeds such as tall morningglory (Ipomoea purpurea), ivyleaf morningglory (Ipomoea hederacea), field bindweed (Convolvulus arvensis) and pitted morningglory (Ipomoea lacunosa);

Portulacaceae weeds such as common purslane (Portulaca oleracea);

Fabaceae weeds such as narrowleaf vetch (Vicia sativa subsp. nigra var. segetalis) and common lespedeza (Kummerowia striata);

Caryophyllaceae weeds such as common chickweed (Stellaria media) and sticky chickweed (Cerastium glomeratum);

Lamiaceae weeds such as henbit (Lamium amplexicaule);

Rubiaceae weeds such as catchweed (Galium spurium);

Commelinaceae weeds such as Asiatic dayflower (Commelina communis); and

Plantaginaceae weeds such as persian speedwell (Veronica persica).

The composition of the present invention is useful to control undesired plants or inhibit their growth, for example, Poaceae weeds, Cyperaceae weeds, Malvaceae weeds, Asteraceae weeds, Solanaceae weeds, Amaranthaceae weeds, Polygonaceae weeds, Brassicaceae weeds, Convolvulaceae weeds, Fabaceae weeds, Caryophyllaceae weeds, Lamiaceae weeds, Rubiaceae weeds, Commelinaceae weeds and Plantaginaceae weeds.

The composition of the present invention is more useful to control undesired plants or inhibit their growth, for example, Poaceae weeds, Asteraceae weeds and Amaranthaceae weeds.

The composition of the present invention is particularly useful to control undesired plants or inhibit their growth, for example, Italian ryegrass (Lolium multiflorum), goosegrass (Eleusine indica), waterhemp (Amaranthus tuberculatus) and horseweed (Conyza canadensis).

The composition of the present invention is used to control the above undesired plants or inhibit their growth, in cultivation of useful plants such as lawn, soybean (Glycine max), alfalfa (Medicago sativa), chickpea (Cicer arietinum), pea (Pisum sativum), lentil (Lens culinaris), cotton (Gossypium spp.), wheat (Triticum aestivum), rice (Oryza sativa), barley (Hordeum vulgare), rye (Secale cereale), oat (Avena sativa), corn (Zea mays), sorghum (Sorghum spp.), Chinese colza (Brassica rapa var. nippo-oleifera), canola (Brassica napus), sunflower (Helianthus annuus), sugar beet (Beta vulgaris ssp. vulgaris, Beta vulgaris var. saccharifera, Beta vulgaris var. hortensis), sugarcane (Saccharum officinarum), peanut (Arachis hypogaea), flax (Linum usitatissimum), tabaco (Nicotiana tabacum) and coffee (Coffea arabica). Thus, the composition of the present invention is used preferably in a place where the above useful plants grow or a place where the above useful plants are cultivated.

The composition of the present invention is used particularly in a place where useful plants grow or a place where the useful plants are cultivated, such as lawn, soybean, cotton, wheat, rice, corn, Chinese colza, canola, sunflower, sugar beet, sugarcane, peanut, flax, tabaco or coffee. The composition of the present invention is used preferably in a place where useful plants grow or a place where the useful plants are cultivated, such as lawn, soybean, wheat, rice or corn. The composition of the present invention is used more preferably in a place where useful plants grow or a place where the useful plants are cultivated, such as soybean, wheat, rice or corn.

The useful plants include plants having, imparted by classical breeding methods, resistance to a herbicide, for example, a HPPD inhibitor such as isoxaflutole, an ALS inhibitor such as imazethapyr or thifensulfuron-methyl, an EPSP synthase inhibitor such as glyphosate, a glutamine synthase inhibitor such as glufosinate, an acetyl CoA carboxylase inhibitor such as sethoxydim, bromoxynil, dicamba, or 2,4-D. The useful plants may, for example, be specifically imidazolinone herbicide resistant corn and canola variety (tradename: Clearfield), and STS soybean resistant to sulfonylurea ALS inhibitor type herbicides.

The useful plants include transgenic plants generated by gene modification. Examples of the transgenic plants include herbicide-resistant transgenic plants, harmful insect-resistant transgenic plants, transgenic plants relating to plant components, and phytopathogen-resistant transgenic plants. Further, the useful plants include stacked varieties having useful characters of such transgenic plants combined.

The composition of the present invention can be effectively used for selectively controlling undesired plants or inhibiting their growth in cultivation of various transgenic plants of the above useful plants (such as soybean, cotton, rapeseed and corn).

The herbicide-resistant transgenic plants include glyphosate-resistant corn, soybean, cotton, rapeseed and sugar beet, glufosinate-resistant com, soybean, cotton and rapeseed, and bromoxynil-resistant cotton.

The harmful insect-resistant transgenic plants include, for example, plants which have acquired the ability to synthesize e.g. toxins known to be synthesized by the genus Bacillus. Toxins synthesized by the transgenic plants impart to the plants resistance particularly to Coleoptera insects, Hemiptera insects, Diptera insects, Lepidoptera insects and nematodes.

The above toxins include insecticidal proteins derived from Bacillus cereus and Bacillus popilliae; o-endotoxins derived from Bacillus thuringiensis, such as Cry1Ab, Cry1Ac, Cry1F, Cry1Fa2, Cry2Ab, Cry3A, Cry3Bb1 and Cry9C; insecticidal proteins such as VIP1, VIP2, VIP3 and VIP3A; insecticidal proteins derived from nematodes; toxins produced by animals, such as scorpion toxin, spider toxin, bee toxin and insect-specific neurotoxin; filamentous fungi toxin; plant lectin; agglutinin; protease inhibitors such as trypsin inhibitor, serine protease inhibitor, patatin, cystatin and papain inhibitor; ribosome-inactivating proteins (RIP) such as ricin, corn-RIP, abrin, luffin, saporin and bryodin; steroid metabolizing enzymes such as 3-hydroxysteroid oxidase, ecdysteroid-UDP-glucosyltransferase and cholesterol oxidase; ecdysone inhibitor; HMG-COA reductase; ion channel blockers such as sodium channel blocker and calcium channel blocker; juvenile hormone esterase; diuretic hormone receptor; stilbene synthase; bibenzyl synthase; chitinase; and glucanase. Further, such toxins include hybrid toxins of o-endotoxin proteins such as Cry1Ab, Cry1Ac, Cry1F, Cry1Fa2, Cry2Ab, Cry3A, Cry3Bb1, Cry9C, Cry34Ab and Cry35Ab, and insecticidal proteins such as VIP1, VIP2, VIP3 and VIP3A, toxins lacking part thereof, and modified toxins.

The transgenic plants relating to plant components include plants having imparted oil component modified character or amino acid content increased character.

The phytopathogen-resistant transgenic plants include plants having imparted the ability to produce anti-pathogen substances with selective action.

The transgenic plants are not particularly limited and may, for example, be specifically corn, soybean, cotton, rapeseed and sugar beet varieties resistant to glyphosate (tradename: RoundupReady, Agrisure, Gly-Tol); corn, soybean, cotton and rapeseed varieties resistant to glufosinate (tradename: LibertyLink); cotton variety resistant to bromoxynil (tradename: BXN); corn and soybean varieties resistant to both glyphosate and ALS inhibitors (tradename: Optimum, GAT); imidazolinone compound resistant variety (tradename: IMI); corn variety expressing Cry1Ab toxin (tradename: YieldGard); corn variety expressing Cry3Bb1 toxin (tradename: YieldGard Rootworm); corn variety expressing Cry1Ab and Cry3Bb1 toxins (tradename: YieldGard Plus); corn variety expressing Cry1Fa2 toxin and phosphinothricin N-acetyltransferase (PAT) for imparting resistance to glufosinate (tradename: Herculex I); cotton variety expressing Cry1Ac toxin (tradename: NuCOTN33B, Bollgard I); cotton variety expressing CrylAc and Cry2Ab toxin (tradename: Bollgard II); cotton variety expressing VIP toxin (tradename: VIPCOT); corn variety expressing Cry1Fa2 toxin and phosphinothricin N-acetyltransferase (PAT) for imparting resistance to glufosinate (Herculex I); variety having GA21 glyphosate-resistant character (tradename: NatureGard Agrisure GT Advantage); variety having Bt11 corn borer (CB) character (tradename: Agrisure CB Advantage); low linolenic acid soybean having reduced linolenic acid content (tradename: VISTIVE); and corn variety having increased lysine or oil content.

The composition of the present invention, which comprises tiafenacil (a1) and the herbicidal compound (a2) in combination, exerts, as compared with a case where the respective active ingredients are applied individually, higher effects, which last over a long period of time, as shown in Examples described later. Thus, it is very useful in practical application, for example, in an application where the effects of the agricultural composition may decrease by rainfall after the application or by the influence of the temperature, etc.

In the present invention, the composition of the present invention may further be mixed with other herbicidal compound as the case requires. Such other herbicidal compound may suitably be selected from among various known herbicidal compounds, considering the application of the composition of the present invention, the type and the growth state of the undesired plants to be controlled, and the like. Further, the composition of the present invention may be mixed with or used in combination with a fungicide, an antibiotic, a plant hormone, an insecticide, a fertilizer, a safener or the like, whereby more excellent effects or function may be obtained in some cases. Such other herbicidal compound includes, for example, the following compounds (common names), and one component or two or more components may properly be selected. Here, as other herbicidal compound to be further mixed, a herbicidal compound different from the herbicidal compound (a2) is selected. That is, in a case where the herbicidal compound (a2) is metribuzin, as other herbicidal compound to be further mixed, a compound other than metribuzin is selected.
(1) Compounds which are believed to exhibit herbicidal effects by disturbing hormone activities of plants, such as phenoxy compounds such as 2,4-D, 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isoctyl, 2,4-D-isopropyl, 2,4-D-isopropylammonium, 2,4-D-sodium, 2,4-D-isopropanolammonium, 2,4-D-trolamine, 2,4-DB, 2,4-DB-butyl, 2,4-DB-dimethylammonium, 2,4-DB-isoctyl, 2,4-DB-potassium, 2,4-DB-sodium, 2,4-D choline salt, dichlorprop, dichlorprop-butotyl, dichlorprop-dimethylammonium, dichlorpropisoctyl, dichlorprop-potassium, dichlorprop-P, dichlorprop-P-dimethylammonium, dichlorprop-P-potassium, dichlorprop-P-sodium, MCPA, MCPA-butotyl, MCPA-dimethylammonium, MCPA-2-ethylhexyl, MCPA-potassium, MCPA-sodium, MCPA-thioethyl, MCPB, MCPB-ethyl, MCPB-sodium, mecoprop, mecoprop-butotyl, mecoprop-sodium, mecoprop-P, mecoprop-P-butotyl, mecoprop-P-dimethylammonium, mecoprop-2-ethylhexyl, mecoprop-P-potassium, naproanilide, clomeprop and HIA-1; aromatic carboxylic acid compounds such as 2,3,6-TBA, dicamba, dicamba-butotyl, dicamba-diglycolamine, dicamba-dimethylammonium, dicamba-diolamine, dicamba-isopropylammonium, dicamba-potassium, dicamba-sodium, picloram, picloram-dimethylammonium, picloram-isoctyl, picloram-potassium, picloram-triisopropanolammonium, picloram-triisopropylammonium, picloram-trolamine, triclopyr, triclopyr-butotyl, triclopyr-triethylammonium, clopyralid, clopyralid-olamine, clopyralid-potassium, clopyralid-triisopropanolammonium, aminopyralid, aminocyclopyrachlor, halauxifen, halauxifen-methyl, indolauxipyr and DAS-534; and other compounds such as naptalam, naptalam-sodium, benazolin, benazolin-ethyl, quinclorac, quinmerac, diflufenzopyr, diflufenzopyr-sodium, fluroxypyr, fluroxypyr-2-butoxy-1-methylethyl, fluroxypyr-meptyl, chlorflurenol, chlorflurenol-methyl, clacyfos and fluchloraminopyr.
(2) Compounds which are believed to exhibit herbicidal effects by inhibiting photosynthesis of plants, such as urea compounds such as chlorotoluron, diuron, fluometuron, linuron, isoproturon, metobenzuron, tebuthiuron, dimefuron, isouron, karbutilate, methabenzthiazuron, metoxuron, metoburomuron, monolinuron, neburon, and siduron; triazine compounds such as terbumeton, trietazine, simazine, atrazine, atratone, simetryn, prometryn, dimethametryn, terbuthylazine, cyanazine, ametryn, cybutryne, terbutryn, propazine, metamitron and prometon; triazinone compounds such as hexazinone, metribuzin and metamitron; uracil compounds such as bromacil, bromacil-lithium, lenacil and terbacil; anilide compounds such as propanil, cypromid, tetflupyrolimet and pentanochlor; carbamate compounds such as desmedipham and phenmedipham; hydroxybenzonitrile compounds such as bromoxynil, bromoxynil-octanoate, bromoxynil-heptanoate, ioxynil, ioxynil-octanoate, ioxynil-potassium and ioxynil-sodium; and other compounds such as pyridate, bentazone, bentazone-sodium, amicarbazone, methazole and chloridazon.
(3) Quaternary ammonium salt compounds such as paraquat and diquat, which are believed to be converted to free radicals by themselves to form active oxygen in the plant body and show rapid herbicidal efficacy.
(4) Compounds which are believed to exhibit herbicidal effects by inhibiting chlorophyll biosynthesis of plants and abnormally accumulating a photosensitizing peroxide substance in the plant body, such as diphenylether compounds such as nitrofen, chlomethoxyfen, bifenox, acifluorfen, acifluorfen-sodium, fomesafen, fomesafen-sodium, oxyfluorfen, lactofen, aclonifen, ethoxyfen-ethyl, fluoroglycofen-ethyl and fluoroglycofen; cyclic imide compounds such as chlorphthalim, flumioxazin, flumiclorac, flumiclorac-pentyl, cinidon-ethyl, fluthiacet-methyl and EK-5385; and other compounds such as oxadiargyl, oxadiazon, sulfentrazone, carfentrazone-ethyl, thidiazimin, pentoxazone, azafenidin, pyraflufen-ethyl, benzfendizone, butafenacil, saflufenacil, epyrifenacil, fluazolate, profluazol, flufenpyr-ethyl, bencarbazone, pyraclonil, cyclopyranil, trifludimoxazin and flufenoximacil.
(5) Compounds which are believed to exhibit herbicidal effects characterized by bleaching activities by inhibiting chromogenesis of plants such as carotenoids, such as pyridazinone compounds such as norflurazon and metflurazon; pyrazole compounds such as pyrazolynate, pyrazoxyfen, benzofenap, topramezone, cypyrafluone, bipyrazone, tolpyralate and pyraquinate; and other compounds such as amitrole, fluridone, flurtamone, diflufenican, methoxyphenone, clomazone, broclozone, bixlozone, mesotrione, tembotrione, tefuryltrione, fenquinotrione, cyclopyrimorate, difenzoquat, difenzoquat-methylsulfate, isoxachlortole, benzobicyclon, bicyclopyrone, picolinafen, beflubutamid, ketospiradox, ketospiradox-potassium and flusulfinam.
(6) Compounds which are believed to exhibit herbicidal effects on plants by inhibiting biosynthesis of fatty acid, such as aryloxyphenoxypropionic acid compounds such as diclofop-methyl, diclofop, pyriphenop-sodium, fluazifop-butyl, fluazifop, fluazifop-P, fluazifop-P-butyl, haloxyfop-methyl, haloxyfop, haloxyfop-etotyl, haloxyfop-P, haloxyfop-P-methyl, quizalofop-ethyl, quizalofop-P, quizalofop-P-ethyl, quizalofop-P-tefuryl, cyhalofop-butyl, fenoxaprop-ethyl, fenoxaprop-P, fenoxaprop-P-ethyl, clodinafop-propargyl, clodinafop, propaquizafop, HNPC-A8169 and SYP-1924; cyclohexanedione compounds such as alloxydim-sodium, alloxydim, clethodim, sethoxydim, tralkoxydim, butroxydim, tepraloxydim, profoxydim and cycloxydim; and phenylpyrazoline compounds such as pinoxaden.
(7) Compounds which are believed to exhibit herbicidal effects by inhibiting an amino acid biosynthesis of plants, such as sulfonylurea compounds such as chlorimuron-ethyl, chlorimuron, sulfometuron-methyl, sulfometuron, primisulfuron-methyl, primisulfuron, bensulfuron-methyl, bensulfuron, chlorsulfuron, metsulfuron-methyl, metsulfuron, cinosulfuron, pyrazosulfuron-ethyl, pyrazosulfuron flazasulfuron, rimsulfuron, nicosulfuron, imazosulfuron, flucetosulfuron, cyclosulfamuron, prosulfuron, flupyrsulfuron-methyl-sodium, flupyrsulfuron, triflusulfuron-methyl, triflusulfuron, halosulfuron-methyl, halosulfuron, thifensulfuron-methyl, thifensulfuron, ethoxysulfuron, oxasulfuron, ethametsulfuron, ethametsulfuron-methyl, iodosulfuron, iodosulfuron-methyl-sodium, sulfosulfuron, triasulfuron, tribenuron-methyl, tribenuron, tritosulfuron, foramsulfuron, trifloxysulfuron, trifloxysulfuron-sodium, mesosulfuron-methyl, mesosulfuron, orthosulfamuron, amidosulfuron, azimsulfuron, propyrisulfuron, metazosulfuron, methiopyrsulfuron, monosulfuron-methyl, iofensulfuron and iofensulfuron-sodium; triazolopyrimidinesulfonamide compounds such as flumetsulam, metosulam, dimesulfazet, diclosulam, cloransulam-methyl, florasulam, penoxsulam and pyroxsulam; imidazolinone compounds such as imazapyr, imazapyr-isopropylammonium, imazethapyr, imazethapyr-ammonium, imazaquin, imazaquin-ammonium, imazamox, imazamox-ammonium, imazamethabenz, imazamethabenz-methyl and imazapic; pyrimidinylsalicylic acid compounds such as pyrithiobac-sodium, bispyribac-sodium, pyriminobac-methyl, pyribenzoxim, pyriftalid and pyriflubenzoxim; sulfonylaminocarbonyltriazolinone compounds such as flucarbazone, flucarbazone-sodium, propoxycarbazone-sodium, propoxycarbazone and thiencarbazone-methyl; sulfoneanilide compounds such as pyrimisulfan and triafamone; and other compounds such as glyphosate, glyphosate-sodium, glyphosate-potassium, glyphosate-ammonium, glyphosate-diammonium, glyphosate-isopropylammonium, glyphosate-trimesium, glyphosate-sesquisodium, glufosinate, glufosinate-ammonium, glufosinate-P, glufosinate-P-ammonium, glufosinate-P-sodium, bilanafos, bilanafos-sodium and cinmethylin.
(8) Compounds which are believed to exhibit herbicidal effects by inhibiting cell mitoses of plants, such as dinitroaniline compounds such as trifluralin, oryzalin, nitralin, pendimethalin, ethalfluralin, benfluralin, prodiamine, butralin and dinitramine; amide compounds such as bensulide, napropamide, napropamide-M, propyzamide, pronamide and beflubutamid-M; organic phosphorus compounds such as amiprofos-methyl, butamifos, anilofos and piperophos; phenyl carbamate compounds such as propham, chlorpropham, barban and carbetamide; cumylamine compounds such as daimuron, cumyluron, bromobutide and methyldymron; and other compounds such as dithiopyr, thiazopyr, chlorthal-dimethyl, chlorthal, diphenamid, flamprop-M-methyl, flamprop-M, flamprop-M-isopropyl and swep.
(9) Compounds which are believed to exhibit herbicidal effects by inhibiting protein biosynthesis or lipid biosynthesis of plants, such as chloroacetamide compounds such as alachlor, metazachlor, butachlor, pretilachlor, metolachlor, S-metolachlor, thenylchlor, pethoxamid, acetochlor, propachlor, dimethenamid, dimethenamid-P, propisochlor and dimethachlor; thiocarbamate compounds such as molinate, dimepiperate, pyributicarb, EPTC, butylate, vernolate, pebulate, cycloate, prosulfocarb, esprocarb, thiobencarb, diallate, tri-allate and orbencarb; and other compounds such as etobenzanid, mefenacet, flufenacet, tridiphane, fentrazamide, oxaziclomefone, benfuresate, pyroxasulfone, dalapon, dalapon-sodium, TCA-sodium and trichloroacetic acid.
(10) Compounds which are believed to exhibit herbicidal effects by inhibiting cellulose biosynthesis of plants, such as dichlobenil, triaziflam, indaziflam, flupoxam and isoxaben.
(11) Other herbicides such as MSMA, DSMA, CMA, endothall, endothall-dipotassium, endothall-sodium, endothall-mono (N,N-dimethylalkylammonium), ethofumesate, sodium chlorate, pelargonic acid, nonanoic acid, fosamine, fosamine-ammonium, ipfencarbazone, acrolein, ammonium sulfamate, borax, chloroacetic acid, sodium chloroacete, cyanamide, methylarsonic acid, dimethylarsinic acid, sodium dimethylarsinate, dinoterb, dinoterb-ammonium, dinoterb-diolamine, dinoterb-acetate, DNOC, ferrous sulfate, flupropanate, flupropanate-sodium, mefluidide, mefluidide-diolamine, metam, metam-ammonium, metam-potassium, metam-sodium, methyl isothiocyanate, pentachlorophenol, sodium pentachlorophenoxide, pentachlorophenol laurate, quinoclamine, sulfuric acid, urea sulfate, xanthinosin, herbimycin, unguinol, metatyrosine, sarmentine, thaxtominA, mevalocidin, alpha-limonene, pyribambenz-propyl, pyribambenz-isopropyl, iptriazopyrid, asulam, asulam-sodium, icafolin, etc.
(12) Microorganisms which are believed to exhibit herbicidal effects by being parasitic on plants, such as Xanthomonas campestris, Exserohilum monoceras or Drechslera monoceras.

One compound or two or more compounds may properly be selected from among the above other herbicidal compounds. The other herbicidal compound is not limited to the above.

With respect to application of the composition of the present invention, application to undesired plants, application to a place where they grow (either before or after emerging of the plants), or application to a place where useful plants are cultivated may optionally be selected. Further, tiafenacil (a1) and the herbicidal compound (a2) may separately be formulated so that they are mixed for use at the time of application, or they may be formulated together, followed by application. As examples of a specific application method, the following may be mentioned.
1. Tiafenacil (a1) and the herbicidal compound (a2) are mixed and formulated together, and the formulation is applied as it is.
2. Tiafenacil (a1) and the herbicidal compound (a2) are mixed and formulated together, and the formulation is diluted to a predetermined concentration with e.g. water, and as the case requires, an agricultural spreader (such as a surfactant, a vegetable oil or a mineral oil) is added to the diluted solution, and the diluted solution is applied.
3. Tiafenacil (a1) and the herbicidal compound (a2) are separately formulated, and the formulations are applied as they are.
4. Tiafenacil (a1) and the herbicidal compound (a2) are separately formulated, and the formulations are separately diluted to predetermined concentrations with e.g. water, and as the case requires, an agricultural spreader (such as a surfactant, a vegetable oil or a mineral oil) is added to the diluted solutions, and the diluted solutions are applied.
5. Tiafenacil (a1) and the herbicidal compound (a2) are separately formulated, and the formulations are mixed when diluted to a predetermined concentration with e.g. water, and as the case requires, an agricultural spreader (such as a surfactant, a vegetable oil or a mineral oil) is added to the diluted solution, and the diluted solution is applied.

The composition of the present invention may be prepared by mixing tiafenacil (a1) and the herbicidal compound (a2), as active ingredients, with various additives in accordance with conventional formulation methods for agricultural chemicals, and applied in the form of various formulations such as dusts, granules, water dispersible granules, wettable powders, tablets, pills, capsules (including a formulation packaged by a water soluble film), water-based suspensions, oil-based suspensions, microemulsions, suspoemulsions, water soluble powders, emulsifiable concentrates, soluble concentrates or pastes. The composition of the present invention may be formed into any formulation which is commonly used in this field, so long as the object of the present invention is thereby met. At the time of the formulation, tiafenacil (a1) and the herbicidal compound (a2) may be formulated together, or they may be separately formulated.

The additives to be used for the formulation include, for example, a solid carrier such as diatomaceous earth, slaked lime, calcium carbonate, talc, white carbon, kaoline, bentonite, kaolinite, sericite, clay, sodium carbonate, sodium bicarbonate, mirabilite, zeolite, starch or saccharides; a solvent such as water, toluene, xylene, solvent naphtha, dioxane, acetone, isophorone, methyl isobutyl ketone, chlorobenzene, cyclohexane, dimethyl sulfoxide, dimethylformamide, dimethylacetamide, N-methyl-2-pyrrolidone or an alcohol (such as propylene glycol); an anionic surfactant or an anionic spreader such as a salt of fatty acid, a benzoate, an alkylsulfosuccinate, a dialkylsulfosuccinate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenyl ether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonate condensed with formaldehyde or an alkylnaphthalene sulfonate condensed with formaldehyde; a nonionic surfactant or a nonionic spreader such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, a polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins.

These additives may suitably be selected for use alone or in combination as a mixture of two or more of them, so long as the object of the present invention is met. Further, various additives commonly used, such as a filler, a thickener, an anti-settling agent, an anti-freezing agent, a dispersion stabilizer, a safer, an anti-mold agent, a blowing agent, a disintegrator and a binder, may be used. The blend ratio of the additives to each of tiafenacil (a1) and the herbicidal compound (a2) or their mixture is, by the weight ratio, about 0.1:99.9 to 99.9:0.1, preferably about 0.2:99.8 to 85:15.

Now, examples of preferred embodiments of the present invention will be given below, but it should be understood that the present invention is by no means restricted thereto.
[1] A method for controlling undesired plants and promoting growth of useful plants, which comprises applying an effective amount of tiafenacil (a1) and an effective amount of at least one herbicidal compound (a2) selected from the following compound group A, to the undesired plants, to a place where the undesired plants grow, or to a place where the useful plants are cultivated;
   compound group A: herbicidal compounds S-metolachlor, metribuzin, pyroxasulfone, pethoxamid, tri-allate and dimethenamid-P.
[2] The method according to [1], wherein the herbicidal compound (a2) is at least one member selected from S-metolachlor, pyroxasulfone, pethoxamid, tri-allate and dimethenamid-P.
[3] The method according to [1], wherein the herbicidal compound (a2) is at least one member selected from S-metolachlor, metribuzin, pyroxasulfone and tri-allate.
[4] The method according to [1], wherein the herbicidal compound (a2) is at least one member selected from S-metolachlor, pyroxasulfone and tri-allate.
[5] The method according to [1], wherein the herbicidal compound (a2) is at least one member selected from S-metolachlor and metribuzin.
[6] The method according to [1], wherein the herbicidal compound (a2) is S-metolachlor or metribuzin.
[7] The method according to [1], wherein the herbicidal compound (a2) is at least one member selected from S-metolachlor and pyroxasulfone.
[8] The method according to [1], wherein the herbicidal compound (a2) is S-metolachlor or pyroxasulfone.
[9] The method according to [1], wherein the herbicidal compound (a2) is at least one member selected from S-metolachlor and tri-allate.
[10] The method according to [1], wherein the herbicidal compound (a2) is S-metolachlor or tri-allate.
[11] The method according to [1], wherein the herbicidal compound (a2) is S-metolachlor.
[12] The method according to any one of [1] to [11], wherein the mixing weight ratio of (a1) to (a2) is from 1:0.8 to 1:1000.
[13] The method according to any one of [1] to [11], wherein the mixing weight ratio of (a1) to (a2) is from 1:1.2 to 1:200.
[14] The method according to any one of [1] to [11], wherein (a1) is applied at a dose of from 0.01 to 400 g/ha, and (a2) is applied at a dose of from 0.1 to 5000 g/ha.
[15] The method according to any one of [1] to [11], wherein (a1) is applied at a dose of from 0.05 to 300 g/ha, and (a2) is applied at a dose of from 1 to 4000 g/ha.
[16] An agricultural composition comprising as active ingredients tiafenacil (a1) and at least one herbicidal compound (a2) selected from the above compound group A, in a mixing weight ratio of (a1) to (a2) of from 1:0.8 to 1:1000.
[17] The agricultural composition according to [16], wherein the mixing weight ratio of (a1) to (a2) is from 1:1.2 to 1:200.
[18] A combination of tiafenacil (a1) and at least one herbicidal compound (a2) selected from the above compound group A as active ingredients, in a mixing weight ratio of (a1) to (a2) of from 1:0.8 to 1:1000.
[19] The agricultural composition according to [16] or [17], wherein the herbicidal compound (a2) is at least one member selected from S-metolachlor, pyroxasulfone, pethoxamid, tri-allate and dimethenamid-P.
[20] The agricultural composition according to [16] or [17], wherein the herbicidal compound (a2) is at least one member selected from S-metolachlor, metribuzin, pyroxasulfone and tri-allate.
[21] The agricultural composition according to [16] or [17], wherein the herbicidal compound (a2) is at least one member selected from S-metolachlor, pyroxasulfone and tri-allate.
[22] The agricultural composition according to [16] or [17], wherein the herbicidal compound (a2) is at least one member selected from S-metolachlor and metribuzin.
[23] The agricultural composition according to [16] or [17], wherein the herbicidal compound (a2) is S-metolachlor or metribuzin.
[24] The agricultural composition according to [16] or [17], wherein the herbicidal compound (a2) is at least one member selected from S-metolachlor and pyroxasulfone.
[25] The agricultural composition according to [16] or [17], wherein the herbicidal compound (a2) is S-metolachlor or pyroxasulfone.
[26] The agricultural composition according to [16] or [17], wherein the herbicidal compound (a2) is at least one member selected from S-metolachlor and tri-allate.
[27] The agricultural composition according to [16] or [17], wherein the herbicidal compound (a2) is S-metolachlor or tri-allate.
[28] The agricultural composition according to [16] or [17], wherein the herbicidal compound (a2) is S-metolachlor.
[29] A method for promoting growth of useful plants, which comprises applying an effective amount of tiafenacil (a1) and an effective amount of at least one herbicidal compound (a2) selected from the following compound group A, to undesired plants, to a place where undesired plants grow, or to a place where the useful plants are cultivated, before the start of cultivation of the useful plants:
   compound group A; herbicidal compounds S-metolachlor, metribuzin, pyroxasulfone, pethoxamid, tri-allate and dimethenamid-P.
[30] The method for promoting growth of useful plants according to [29], wherein the herbicidal compound (a2) is S-metolachlor.
[31] A method for increasing the harvest of useful plants, which comprises applying an effective amount of tiafenacil (a1) and an effective amount of at least one herbicidal compound (a2) selected from the following compound group A, to undesired plants, to a place where undesired plants grow, or to a place where the useful plants are cultivated;
   compound group A: herbicidal compounds S-metolachlor, metribuzin, pyroxasulfone, pethoxamid, tri-allate and dimethenamid-P.
[32] The method according to [31], wherein the herbicidal compound (a2) is S-metolachlor.
[33] A method for promoting growth of useful plants, which comprises applying an effective amount of tiafenacil (a1) and an effective amount of at least one herbicidal compound (a2) selected from the following compound group A, to undesired plants, to a place where undesired plants grow, or to a place where the useful plants are cultivated;
   compound group A: herbicidal compounds S-metolachlor, metribuzin, pyroxasulfone, pethoxamid, tri-allate and dimethenamid-P.
[34] The method according to [33], wherein the herbicidal compound (a2) is S-

metolachlor.

### EXAMPLES

Now, Examples of the present invention will be described, however, the present invention is by no means restricted thereto.

First, tests on the herbicidal effect of the composition of the present invention on undesired plants will be described.

### (1) Herbicidal Effect Test (Italian Ryegrass (Lolium Multiflorum))

Upland soil was put in a 1/1,000,000 hectare pot, and seeds of Italian ryegrass (Lolium multiflorum) were sown. When the Italian ryegrass reached 2.3 to 3.0 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 6th day after spraying, the state of growth of the Italian ryegrass was visually observed, and the growth inhibition rate (%) was obtained based on the following standards and the results are shown in Table 1.

$$Evaluation standards : Growth inhibition rate ( \% ) = 0 ( equivalent to the non - treated area ) to 100 ( complete kill )$$

Further, the expected value of the growth inhibition rate (%) was calculated in accordance with the following Colby's formula (S. R. Colby, “Weeds”, vol. 15 (1067), p. 20-22) and the results are also shown in Table 1.

$$Colby ’ s formula : E = X + Y - ( X \cdot Y / 100 )$$

X: growth inhibition rate when treated with α (g/ha) of compound A,
Y: growth inhibition rate when treated with β (g/ha) of compound B,
E: growth inhibition rate expected when treated with α (g/ha) of compound A and β (g/ha) of compound B (expected value).

That is, when the growth inhibition rate of the composition of the present invention is higher than E (expected value of growth inhibition rate) calculated by the above formula, the combination can be regarded as having a synergistic effect.

It is found from Table 1 that use of tiafenacil (a1) and S-metolachlor (a2) in combination has improved controlling effects on Italian ryegrass as compared with single use of each ingredient. The growth inhibition rates by use of tiafenacil (a1) and S-metolachlor (a2) in combination, in all combinations of doses, are higher than the expected values, and thus the use in combination is found to have a synergistic effect.

TABLE 1

| | | Growth inhibition |
|---|---|---|
| | | rate (%) |
| | | Measured value |
| Test Compound | Dose (g/ha) | (expected value) |
| tiafenacil + | 25 + 3000 | 99(84) |
| S-metolachlor | 25 + 1500 | 98(84) |
| | 25 + 750 | 99(84) |
| | 25 + 375 | 99(84) |
| | 25 + 250 | 98(83) |
| | 12.5 + 1500 | 98(76) |
| | 12.5 + 750 | 98(76) |
| | 12.5 + 375 | 98(76) |
| | 12.5 + 250 | 97(75) |
| | 12.5 + 125 | 93(75) |
| tiafenacil | 25 | 83 |
| | 12.5 | 75 |
| S-metolachlor | 3000 | 5 |
| | 1500 | 5 |
| | 750 | 4 |
| | 375 | 3 |
| | 250 | 1 |
| | 125 | 0 |

### (2) Herbicidal Effect Test (Italian Ryegrass (Lolium Multiflorum))

Upland soil was put in a 1/1,000,000 hectare pot, and seeds of Italian ryegrass (Lolium multiflorum) were sown. When the Italian ryegrass reached 2.5 to 3.0 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 16th day after spraying, the state of growth of the Italian ryegrass was visually observed, and the growth inhibition rate (%) was obtained in accordance with the evaluation standards described in the above (1) herbicidal effect test, and the results are shown in Table 2. Further, the expected value of the growth inhibition rate (%) was calculated in accordance with the Colby's formula described in the above (1) herbicidal effect test, and the results are also shown in Table 2.

It is found from Table 2 that use of tiafenacil (a1) and S-metolachlor (a2) in combination has improved controlling effects on Italian ryegrass as compared with single use of each ingredient. The growth inhibition rates by use of tiafenacil (a1) and S-metolachlor (a2) in combination, in all combinations of doses, are higher than the expected values, and thus the use in combination is found to have a synergistic effect.

TABLE 2

| | | Growth inhibition |
|---|---|---|
| | | rate (%) |
| | | Measured value |
| Test Compound | Dose (g/ha) | (expected value) |
| tiafenacil + | 12.5 + 3000 | 88(81) |
| S-metolachlor | 12.5 + 1500 | 87(69) |
| | 12.5 + 750 | 80(35) |
| | 12.5 + 125 | 73(30) |
| | 12.5 + 62.5 | 77(30) |
| tiafenacil | 12.5 | 30 |
| S-metolachlor | 3000 | 73 |
| | 1500 | 55 |
| | 750 | 7 |
| | 125 | 0 |
| | 62.5 | 0 |

### (3) Herbicidal Effect Test (Italian Ryegrass (Lolium Multiflorum))

Upland soil was put in a 1/1,000,000 hectare pot, and seeds of Italian ryegrass (Lolium multiflorum) were sown. When the Italian ryegrass reached 2.8 to 3.2 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 7th day after spraying, the state of growth of the Italian ryegrass was visually observed, and the growth inhibition rate (%) was obtained in accordance with the evaluation standards described in the above (1) herbicidal effect test, and the results are shown in Table 3. Further, the expected value of the growth inhibition rate (%) was calculated in accordance with the Colby's formula described in the above (1) herbicidal effect test, and the results are also shown in Table 3.

It is found from Table 3 that use of tiafenacil (a1) and S-metolachlor (a2) in combination at specific doses has improved controlling effects on Italian ryegrass as compared with single use of each ingredient. The growth inhibition rates by use of tiafenacil (a1) and S-metolachlor (a2) in combination, in a specific combination of doses, is higher than the expected value, and thus the use in combination is found to have a synergistic effect.

TABLE 3

| | | Growth inhibition |
|---|---|---|
| | | rate (%) |
| | | Measured value |
| Test Compound | Dose (g/ha) | (expected value) |
| tiafenacil + | 12.5 + 15.6 | 89(53) |
| S-metolachlor | | |
| tiafenacil | 12.5 | 53 |
| S-metolachlor | 15.6 | 0 |

### (4) Herbicidal Effect Test (Italian Ryegrass (Lolium Multiflorum))

Upland soil was put in a 1/1,000,000 hectare pot, and seeds of Italian ryegrass (Lolium multiflorum) were sown. When the Italian ryegrass reached 2.5 to 3.0 leaf stage, a water-based suspension containing tiafenacil as the active ingredient, prepared by a conventional method for preparing a water-based suspension, and a wettable powder containing metribuzin as the active ingredient (tradename: SENCOR wettable powder, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation).

On the 7th day after spraying, the state of growth of the Italian ryegrass was visually observed, and the growth inhibition rate (%) was obtained in accordance with the evaluation standards described in the above (1) herbicidal effect test, and the results are shown in Table 4. Further, the expected value of the growth inhibition rate (%) was calculated in accordance with the Colby's formula described in the above (1) herbicidal effect test, and the results are also shown in Table 4.

It is found from Table 4 that use of tiafenacil (a1) and metribuzin (a2) in combination has improved controlling effects on Italian ryegrass as compared with single use of each ingredient. The growth inhibition rates by use of tiafenacil (a1) and metribuzin (a2) in combination, in all combinations of doses, are higher than the expected values, and thus the use in combination is found to have a synergistic effect.

TABLE 4

| | | Growth inhibition |
|---|---|---|
| | | rate (%) |
| | | Measured value |
| Test Compound | Dose (g/ha) | (expected value) |
| tiafenacil + | 6.25 + 1100 | 93(92) |
| metribuzin | 6.25 + 550 | 92(70) |
| | 6.25 + 275 | 75(62) |
| | 6.25 + 9.38 | 62(30) |
| tiafenacil | 6.25 | 30 |
| metribuzin | 1100 | 88 |
| | 550 | 57 |
| | 275 | 45 |
| | 9.38 | 0 |

### (5) Herbicidal Effect Test (Italian Ryegrass (Lolium Multiflorum))

Upland soil was put in a 1/1,000,000 hectare pot, and seeds of Italian ryegrass (Lolium multiflorum) were sown. When the Italian ryegrass reached 3.0 to 3.3 leaf stage, a water-based suspension containing tiafenacil as the active ingredient, prepared by a conventional method for preparing a water-based suspension, and a wettable powder containing metribuzin as the active ingredient (tradename: SENCOR wettable powder, manufactured by Bayer Crop Science), water dispersible granules containing pyroxasulfone as the active ingredient (tradename: Sakura, manufactured by Bayer Crop Science) or a wettable powder containing tri-allate as the active ingredient, prepared by a conventional method for preparing a wettable powder, were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 6th day after spraying, the state of growth of the Italian ryegrass was visually observed, and the growth inhibition rate (%) was obtained in accordance with the evaluation standards described in the above (1) herbicidal effect test, and the results are shown in Table 5. Further, the expected value of the growth inhibition rate (%) was calculated in accordance with the Colby's formula described in the above (1) herbicidal effect test, and the results are also shown in Table 5.

It is found from Table 5 that use of tiafenacil (a1) and metribuzin, pyroxasulfone or tri-allate (a2) in combination has improved controlling effects on Italian ryegrass as compared with single use of each ingredient. The growth inhibition rates by use of tiafenacil (a1) and metribuzin, pyroxasulfone or tri-allate (a2) in combination, in all combinations, are higher than the expected values, and thus the use in combination is found to have a synergistic effect.

TABLE 5

| | | Growth inhibition |
|---|---|---|
| | | rate (%) |
| | | Measured value |
| Test Compound | Dose (g/ha) | (expected value) |
| tiafenacil + | 6.25 + 550 | 86(53) |
| metribuzin | 6.25 + 275 | 77(53) |
| | 3.13 + 275 | 72(42) |
| | 3.13 + 137.5 | 62(34) |
| tiafenacil + | 12.5 + 250 | 94(69) |
| pyroxasulfone | 12.5 + 125 | 96(67) |
| | 12.5 + 62.5 | 78(63) |
| | 12.5 + 15 | 77(61) |
| | 6.25 + 125 | 79(44) |
| | 6.25 + 62.5 | 77(38) |
| | 6.25 + 15 | 63(35) |
| | 6.25 + 7.5 | 58(33) |
| tiafenacil + | 12.5 + 1250 | 90(62) |
| tri-allate | 12.5 + 625 | 93(61) |
| | 12.5 + 150 | 94(60) |
| | 6.25 + 1250 | 68(36) |
| | 6.25 + 625 | 68(34) |
| | 6.25 + 150 | 60(33) |
| | 6.25 + 75 | 52(33) |
| tiafenacil | 12.5 | 60 |
| | 6.25 | 33 |
| | 3.13 | 17 |
| metribuzin | 550 | 30 |
| | 275 | 30 |
| | 137.5 | 20 |
| pyroxasulfone | 250 | 23 |
| | 125 | 17 |
| | 62.5 | 8 |
| | 15 | 3 |
| | 7.5 | 0 |
| tri-allate | 1250 | 5 |
| | 625 | 2 |
| | 150 | 0 |
| | 75 | 0 |

### (6) Herbicidal Effect Test (Italian Ryegrass (Lolium Multiflorum))

Upland soil was put in a 1/1,000,000 hectare pot, and seeds of Italian ryegrass (Lolium multiflorum) were sown. When the Italian ryegrass reached 2.5 to 3.0 leaf stage, a water-based suspension containing tiafenacil as the active ingredient, prepared by a conventional method for preparing a water-based suspension, and water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 14th day after spraying, the state of growth of the Italian ryegrass was visually observed, and the growth inhibition rate (%) was obtained in accordance with the evaluation standards described in the above (1) herbicidal effect test, and the results are shown in Table 6. Further, the expected value of the growth inhibition rate (%) was calculated in accordance with the Colby's formula described in the above (1) herbicidal effect test, and the results are also shown in Table 6.

It is found from Table 6 that use of tiafenacil (a1) and pyroxasulfone (a2) in combination has improved controlling effects on Italian ryegrass as compared with single use of each ingredient. The growth inhibition rates by use of tiafenacil (a1) and pyroxasulfone (a2) in combination, in all combinations of doses, are higher than the expected values, and thus the use in combination is found to have a synergistic effect.

TABLE 6

| | | Growth inhibition |
|---|---|---|
| | | rate (%) |
| | | Measured value |
| Test Compound | Dose (g/ha) | (expected value) |
| tiafenacil + | 12.5 + 1000 | 99(90) |
| pyroxasulfone | 12.5 + 500 | 99(88) |
| | 12.5 + 250 | 99(79) |
| | 12.5 + 125 | 98(76) |
| | 12.5 + 30 | 97(65) |
| | 12.5 + 15 | 95(63) |
| tiafenacil | 12.5 | 63 |
| pyroxasulfone | 1000 | 72 |
| | 500 | 67 |
| | 250 | 42 |
| | 125 | 35 |
| | 30 | 5 |
| | 15 | 0 |

### (7) Herbicidal Effect Test (Italian Tyegrass (Lolium Multiflorum))

Upland soil was put in a 1/1,000,000 hectare pot, and seeds of Italian ryegrass (Lolium multiflorum) were sown. When Italian ryegrass reached 2.8 to 3.0 leaf stage, a water-based suspension containing tiafenacil as the active ingredient, prepared by a conventional method for preparing a water-based suspension, and an emulsifiable concentrate containing pethoxamid as the active ingredient (tradename: Successor 600, manufactured by Stahler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 7th day after spraying, the state of growth of the Italian ryegrass was visually observed, and the growth inhibition rate (%) was obtained in accordance with the evaluation standards described in the above (1) herbicidal effect test, and the results are shown in Table 7. Further, the expected value of the growth inhibition rate (%) was calculated in accordance with the Colby's formula described in the above (1) herbicidal effect test, and the results are also shown in Table 7.

It is found from Table 7 that use of tiafenacil (a1) and pethoxamid or dimethenamid-P (a2) in combination has improved controlling effects on Italian ryegrass as compared with single use of each ingredient. The growth inhibition rates by use of tiafenacil (a1) and pethoxamid or dimethenamid-P (a2) in combination, in all combinations, are higher than the expected values, and thus the use in combination is found to have a synergistic effect.

TABLE 7

| | | Growth inhibition |
|---|---|---|
| | | rate (%) |
| | | Measured value |
| Test Compound | Dose (g/ha) | (expected value) |
| tiafenacil + | 12.5 + 1500 | 68(45) |
| pethoxamid | 12.5 + 375 | 57(41) |
| | 12.5 + 187.5 | 52(37) |
| | 6.25 + 750 | 33(21) |
| | 6.25 + 187.5 | 30(15) |
| | 6.25 + 93.75 | 43(15) |
| tiafenacil + | 12.5 + 1500 | 87(46) |
| dimethenamid-P | 12.5 + 750 | 87(45) |
| | 12.5 + 240 | 83(42) |
| | 12.5 + 120 | 86(39) |
| | 6.25 + 750 | 62(25) |
| | 6.25 + 240 | 62(22) |
| | 6.25 + 120 | 62(18) |
| | 6.25 + 60 | 55(15) |
| tiafenacil | 25 | 33 |
| | 12.5 | 37 |
| | 6.25 | 15 |
| pethoxamid | 1500 | 12 |
| | 750 | 7 |
| | 375 | 7 |
| | 187.5 | 0 |
| | 93.75 | 0 |
| dimethenamid-P | 1500 | 15 |
| | 750 | 12 |
| | 240 | 8 |
| | 120 | 3 |
| | 60 | 0 |

### (8) Herbicidal Effect Test (Italian Ryegrass (Lolium Multiflorum))

Upland soil was put in a 1/1,000,000 hectare pot, and seeds of Italian ryegrass (Lolium multiflorum) were sown. When Italian ryegrass reached 3.0 to 3.1 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science) or water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 4th day after spraying, the state of growth of the Italian ryegrass was visually observed, and the growth inhibition rate (%) was obtained in accordance with the evaluation standards described in the above (1) herbicidal effect test, and the results are shown in Table 8. Further, the expected value of the growth inhibition rate (%) was calculated in accordance with the Colby's formula described in the above (1) herbicidal effect test, and the results are also shown in Table 8.

It is found from Table 8 that use of tiafenacil (a1) and S-metolachlor, metribuzin or pyroxasulfone (a2) in combination has improved controlling effects on Italian ryegrass as compared with single use of each ingredient. The growth inhibition rates by use of tiafenacil (a1) and S-metolachlor, metribuzin or pyroxasulfone (a2) in combination, in all combinations, are higher than the expected values, and thus the use in combination is found to have a synergistic effect.

TABLE 8

| | | Growth inhibition |
|---|---|---|
| | | rate (%) |
| | | Measured value |
| Test Compound | Dose (g/ha) | (expected value) |
| tiafenacil + | 6.25 + 625 | 91(30) |
| S-metolachlor | 6.25 + 500 | 91(28) |
| | 6.25 + 281 | 89(26) |
| tiafenacil + | 6.25 + 938 | 98(46) |
| metribuzin | 6.25 + 750 | 94(36) |
| | 6.25 + 438 | 93(28) |
| | 6.25 + 125 | 90(22) |
| tiafenacil + | 6.25 + 375 | 96(36) |
| pyroxasulfone | 6.25 + 188 | 95(28) |
| tiafenacil | 6.25 | 20 |
| S-metolachlor | 625 | 13 |
| | 500 | 10 |
| | 281 | 7 |
| metribuzin | 938 | 33 |
| | 750 | 20 |
| | 438 | 10 |
| | 125 | 3 |
| pyroxasulfone | 375 | 20 |
| | 188 | 10 |

### (9) Herbicidal Effect Test (Italian Ryegrass (Lolium Multiflorum))

Upland soil was put in a 1/1,000,000 hectare pot, and seeds of Italian ryegrass (Lolium multiflorum) were sown. When Italian ryegrass reached 3.2 to 4.0 leaf stage, a water-based suspension containing tiafenacil as the active ingredient, prepared by a conventional method for preparing a water-based suspension, and a wettable powder containing tri-allate as the active ingredient, prepared by a conventional method for preparing a wettable powder, an emulsifiable concentrate containing pethoxamid as the active ingredient (tradename: Successor 600, manufactured by Stähler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 6th day after spraying, the state of growth of the Italian ryegrass was visually observed, and the growth inhibition rate (%) was obtained in accordance with the evaluation standards described in the above (1) herbicidal effect test, and the results are shown in Table 9. Further, the expected value of the growth inhibition rate (%) was calculated in accordance with the Colby's formula described in the above (1) herbicidal effect test, and the results are also shown in Table 9.

It is found from Table 9 that use of tiafenacil (a1) and tri-allate, pethoxamid or dimethenamid-P (a2) in combination has improved controlling effects on Italian ryegrass as compared with single use of each ingredient. The growth inhibition rates by use of tiafenacil (a1) and tri-allate, pethoxamid or dimethenamid-P (a2) in combination, in all combinations, are higher than the expected values, and thus the use in combination is found to have a synergistic effect.

TABLE 9

| | | Growth inhibition |
|---|---|---|
| | | rate (%) |
| | | Measured value |
| Test Compound | Dose (g/ha) | (expected value) |
| tiafenacil + | 6.25 + 937.5 | 75(32) |
| tri-allate | | |
| tiafenacil + | 6.25 + 625 | 77(36) |
| pethoxamid | 6.25 + 437.5 | 63(32) |
| | 6.25 + 312.5 | 81(34) |
| tiafenacil + | 6.25 + 625 | 88(58) |
| dimethenamid-P | 6.25 + 500 | 89(53) |
| tiafenacil | 6.25 | 30 |
| tri-allate | 937.5 | 3 |
| pethoxamid | 625 | 8 |
| | 437.5 | 3 |
| | 312.5 | 5 |
| dimethenamid-P | 625 | 40 |
| | 500 | 33 |

### (10) Herbicidal Effect Test (Goosegrass (Eleusine Indica))

Upland soil was put in a 1/1,000,000 hectare pot, and seeds of goosegrass (Eleusine indica) were sown. When the goosegrass reached 6.5 to 7.8 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science) or water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 13th day after spraying, the state of growth of the goosegrass was visually observed, and the growth inhibition rate (%) was obtained in accordance with the evaluation standards described in the above (1) herbicidal effect test, and the results are shown in Table 10. Further, the expected value of the growth inhibition rate (%) was calculated in accordance with the Colby's formula described in the above (1) herbicidal effect test, and the results are also shown in Table 10.

It is found from Table 10 that use of tiafenacil (a1) and S-metolachlor, metribuzin or pyroxasulfone (a2) in combination has improved controlling effects on goosegrass as compared with single use of each ingredient. The growth inhibition rates by use of tiafenacil (a1) and S-metolachlor, metribuzin or pyroxasulfone (a2) in combination, in all combinations, are higher than the expected values, and thus the use in combination is found to have a synergistic effect.

TABLE 10

| | | Growth inhibition rate |
|---|---|---|
| | | (%) |
| | | Measured value |
| Test Compound | Dose (g/ha) | (expected value) |
| tiafenacil + | 6.25 + 750 | 94(35) |
| S-metolachlor | 6.25 + 375 | 97(35) |
| | 6.25 + 7.5 | 96(35) |
| tiafenacil + | 6.25 + 1100 | 99(80) |
| metribuzin | 6.25 + 550 | 96(78) |
| | 6.25 + 9.38 | 96(35) |
| tiafenacil + | 6.25 + 500 | 98(31) |
| pyroxasulfone | 6.25 + 250 | 96(31) |
| | 6.25 + 7.5 | 96(30) |
| tiafenacil | 6.25 | 30 |
| S-metolachlor | 750 | 7 |
| | 375 | 7 |
| | 7.5 | 7 |
| metribuzin | 1100 | 72 |
| | 550 | 68 |
| | 9.38 | 7 |
| pyroxasulfone | 500 | 2 |
| | 250 | 2 |
| | 7.5 | 0 |

### (11) Herbicidal Effect Test (Goosegrass (Eleusine Indica))

Upland soil was put in a 1/1,000,000 hectare pot, and seeds of goosegrass (Eleusine indica) were sown. When goosegrass reached 7.0 to 8.3 leaf stage, a water-based suspension containing tiafenacil as the active ingredient, prepared by a conventional method for preparing a water-based suspension, and a wettable powder containing tri-allate as the active ingredient, prepared by a conventional method for preparing a wettable powder, an emulsifiable concentrate containing pethoxamid as the active ingredient (tradename: Successor 600, manufactured by Stähler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 3rd day after spraying, the state of growth of the goosegrass was visually observed, and the growth inhibition rate (%) was obtained in accordance with the evaluation standards described in the above (1) herbicidal effect test, and the results are shown in Table 11. Further, the expected value of the growth inhibition rate (%) was calculated in accordance with the Colby's formula described in the above (1) herbicidal effect test, and the results are also shown in Table 11.

It is found from Table 11 that use of tiafenacil (a1) and tri-allate, pethoxamid or dimethenamid-P (a2) in combination has improved controlling effects on goosegrass as compared with single use of each ingredient. The growth inhibition rates by use of tiafenacil (a1) and tri-allate, pethoxamid or dimethenamid-P (a2) in combination, in all combinations, are higher than the expected values, and thus the use in combination is found to have a synergistic effect.

TABLE 11

| | | Growth inhibition rate |
|---|---|---|
| | | (%) |
| | | Measured value |
| Test Compound | Dose (g/ha) | (expected value) |
| tiafenacil + | 6.25 + 1250 | 95(78) |
| tri-allate | 6.25 + 625 | 95(77) |
| | 6.25 + 75 | 93(77) |
| tiafenacil + | 6.25 + 750 | 94(77) |
| pethoxamid | 6.25 + 375 | 94(77) |
| | 6.25 + 93.8 | 95(77) |
| tiafenacil + | 6.25 + 750 | 95(77) |
| dimethenamid-P | 6.25 + 375 | 95(77) |
| | 6.25 + 60 | 95(77) |
| tiafenacil | 6.25 | 77 |
| tri-allate | 1250 | 5 |
| | 625 | 0 |
| | 75 | 0 |
| pethoxamid | 750 | 0 |
| | 375 | 0 |
| | 93.8 | 0 |
| dimethenamid-P | 750 | 0 |
| | 375 | 0 |
| | 60 | 0 |

### (12) Herbicidal Effect Test (Waterhemp (Amaranthus Tuberculatus))

Upland soil was put in a 1/1,000,000 hectare pot, and seeds of waterhemp (Amaranthus tuberculatus) were sown. When waterhemp reached 6.0 to 8.5 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science) or water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 13th day after spraying, the state of growth of the waterhemp was visually observed, and the growth inhibition rate (%) was obtained in accordance with the evaluation standards described in the above (1) herbicidal effect test, and the results are shown in Table 12. Further, the expected value of the growth inhibition rate (%) was calculated in accordance with the Colby's formula described in the above (1) herbicidal effect test, and the results are also shown in Table 12.

It is found from Table 12 that use of tiafenacil (a1) and S-metolachlor, metribuzin or pyroxasulfone (a2) in combination has improved controlling effects on waterhemp as compared with single use of each ingredient. The growth inhibition rates by use of tiafenacil (a1) and S-metolachlor, metribuzin or pyroxasulfone (a2) in combination, in all combinations, are higher than the expected values, and thus the use in combination is found to have a synergistic effect.

TABLE 12

| | | Growth inhibition rate |
|---|---|---|
| | | (%) |
| | | Measured value |
| Test Compound | Dose (g/ha) | (expected value) |
| tiafenacil + | 6.25 + 750 | 97(33) |
| S-metolachlor | 6.25 + 375 | 96(33) |
| | 6.25 + 7.5 | 93(33) |
| tiafenacil + | 6.25 + 1100 | 97(67) |
| metribuzin | 6.25 + 550 | 96(58) |
| | 6.25 + 9.38 | 93(36) |
| tiafenacil + | 6.25 + 500 | 98(42) |
| pyroxasulfone | 6.25 + 250 | 97(44) |
| | 6.25 + 7.5 | 97(40) |
| tiafenacil | 6.25 | 33 |
| S-metolachlor | 750 | 0 |
| | 375 | 0 |
| | 7.5 | 0 |
| metribuzin | 1100 | 50 |
| | 550 | 37 |
| | 9.38 | 5 |
| pyroxasulfone | 500 | 13 |
| | 250 | 17 |
| | 7.5 | 10 |

### (13) Herbicidal Effect Test (Waterhemp (Amaranthus Tuberculatus))

Upland soil was put in a 1/1,000,000 hectare pot, and seeds of waterhemp (Amaranthus tuberculatus) were sown. When the waterhemp reached 5.0 to 8.0 leaf stage, a water-based suspension containing tiafenacil as the active ingredient, prepared by a conventional method for preparing a water-based suspension, and a wettable powder containing tri-allate as the active ingredient, prepared by a conventional method for preparing a wettable powder, an emulsifiable concentrate containing pethoxamid as the active ingredient (tradename: Successor 600, manufactured by Stähler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 4th day after spraying, the state of growth of the waterhemp was visually observed, and the growth inhibition rate (%) was obtained in accordance with the evaluation standards described in the above (1) herbicidal effect test, and the results are shown in Table 13. Further, the expected value of the growth inhibition rate (%) was calculated in accordance with the Colby's formula described in the above (1) herbicidal effect test, and the results are also shown in Table 13.

It is found from Table 13 that use of tiafenacil (a1) and tri-allate, pethoxamid or dimethenamid-P (a2) in combination has improved controlling effects on waterhemp as compared with single use of each ingredient. The growth inhibition rates by use of tiafenacil (a1) and tri-allate, pethoxamid or dimethenamid-P (a2) in combination, in all combinations, are higher than the expected values, and thus the use in combination is found to have a synergistic effect.

TABLE 13

| | | Growth inhibition rate |
|---|---|---|
| | | (%) |
| | | Measured value |
| Test Compound | Dose (g/ha) | (expected value) |
| tiafenacil + | 6.25 + 1250 | 92(73) |
| tri-allate | 6.25 + 625 | 93(73) |
| | 6.25 + 75 | 90(73) |
| tiafenacil + | 6.25 + 750 | 93(73) |
| pethoxamid | 6.25 + 375 | 92(73) |
| | 6.25 + 93.8 | 93(73) |
| tiafenacil + | 6.25 + 750 | 92(73) |
| dimethenamid-P | 6.25 + 375 | 91(73) |
| | 6.25 + 60 | 92(73) |
| tiafenacil | 6.25 | 73 |
| tri-allate | 1250 | 0 |
| | 625 | 0 |
| | 75 | 0 |
| pethoxamid | 750 | 0 |
| | 375 | 0 |
| | 93.8 | 0 |
| dimethenamid-P | 750 | 0 |
| | 375 | 0 |
| | 60 | 0 |

### (14) Herbicidal Effect Test (Horseweed (Conyza Canadensis))

Upland soil was put in a 1/1,000,000 hectare pot, and seeds of horseweed (Conyza canadensis) were sown. When the horseweed reached a diameter of 12 to 17 cm, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science) or water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 6th day after spraying, the state of growth of the horseweed was visually observed, and the growth inhibition rate (%) was obtained in accordance with the evaluation standards described in the above (1) herbicidal effect test, and the results are shown in Table 14. Further, the expected value of the growth inhibition rate (%) was calculated in accordance with the Colby's formula described in the above (1) herbicidal effect test, and the results are also shown in Table 14.

It is found from Table 14 that use of tiafenacil (a1) and S-metolachlor, metribuzin or pyroxasulfone (a2) in combination has improved controlling effects on horseweed as compared with single use of each ingredient. The growth inhibition rates by use of tiafenacil (a1) and S-metolachlor, metribuzin or pyroxasulfone (a2) in combination, in all combinations, are higher than the expected values, and thus the use in combination is found to have a synergistic effect.

TABLE 14

| | | Growth inhibition rate |
|---|---|---|
| | | (%) |
| | | Measured value |
| Test Compound | Dose (g/ha) | (expected value) |
| tiafenacil + | 6.25 + 750 | 65(23) |
| S-metolachlor | 6.25 + 375 | 53(23) |
| | 6.25 + 7.5 | 48(23) |
| tiafenacil + | 6.25 + 1100 | 72(27) |
| metribuzin | 6.25 + 550 | 58(27) |
| | 6.25 + 9.38 | 67(23) |
| tiafenacil + | 6.25 + 500 | 62(23) |
| pyroxasulfone | 6.25 + 250 | 62(23) |
| | 6.25 + 7.5 | 63(23) |
| tiafenacil | 6.25 | 23 |
| S-metolachlor | 750 | 0 |
| | 375 | 0 |
| | 7.5 | 0 |
| metribuzin | 1100 | 5 |
| | 550 | 5 |
| | 9.38 | 0 |
| pyroxasulfone | 500 | 0 |
| | 250 | 0 |
| | 7.5 | 0 |

### (15) Herbicidal Effect Test (Horseweed (Conyza Canadensis))

Upland soil was put in a 1/1,000,000 hectare pot, and seeds of horseweed (Conyza canadensis) were sown. When the horseweed reached a diameter of 13 to 19 cm, a water-based suspension containing tiafenacil as the active ingredient, prepared by a conventional method for preparing a water-based suspension, and a wettable powder containing tri-allate as the active ingredient, prepared by a conventional method for preparing a wettable powder, an emulsifiable concentrate containing pethoxamid as the active ingredient (tradename: Successor 600, manufactured by Stähler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 3rd day after spraying, the state of growth of the horseweed was visually observed, and the growth inhibition rate (%) was obtained in accordance with the evaluation standards described in the above (1) herbicidal effect test, and the results are shown in Table 15. Further, the expected value of the growth inhibition rate (%) was calculated in accordance with the Colby's formula described in the above (1) herbicidal effect test, and the results are also shown in Table 15.

It is found from Table 15 that use of tiafenacil (a1) and tri-allate, pethoxamid or dimethenamid-P (a2) in combination has improved controlling effects on horseweed as compared with single use of each ingredient. The growth inhibition rates by use of tiafenacil (a1) and tri-allate, pethoxamid or dimethenamid-P (a2) in combination, in all combinations, are higher than the expected values, and thus the use in combination is found to have a synergistic effect.

TABLE 15

| | | Growth inhibition rate |
|---|---|---|
| | | (%) |
| | | Measured value |
| Test Compound | Dose (g/ha) | (expected value) |
| tiafenacil + | 6.25 + 1250 | 42(19) |
| tri-allate | 6.25 + 625 | 48(21) |
| | 6.25 + 75 | 43(17) |
| tiafenacil + | 6.25 + 750 | 45(17) |
| pethoxamid | 6.25 + 375 | 48(17) |
| | 6.25 + 93.8 | 42(17) |
| tiafenacil + | 6.25 + 750 | 48(17) |
| dimethenamid-P | 6.25 + 375 | 48(17) |
| | 6.25 + 60 | 50(17) |
| tiafenacil | 6.25 | 17 |
| tri-allate | 1250 | 3 |
| | 625 | 5 |
| | 75 | 0 |
| pethoxamid | 750 | 0 |
| | 375 | 0 |
| | 93.8 | 0 |
| dimethenamid-P | 750 | 0 |
| | 375 | 0 |
| | 60 | 0 |

Now, a comparative test between the composition of the present invention and a composition containing other herbicidal compound instead of tiafenacil, will be described.

### (16) Herbicidal Effect Test (Comparative Test)

Upland soil was put in a 1/1,000,000 hectare pot, and seeds of Italian ryegrass (Lolium multiflorum) were sown. When Italian ryegrass reached 2.5 to 3.0 leaf stage, a water-based suspension containing tiafenacil as the active ingredient, prepared by a conventional method for preparing a water-based suspension, a water-based suspension containing saflufenacil as the active ingredient (tradename: Sharpen, manufactured by BASF), a wettable powder containing fomesafen as the active ingredient, prepared by a conventional method for preparing a wettable powder, an emulsifiable concentrate containing fluthiacet-methyl as the active ingredient (tradename: Attackshot emulsifiable concentrate, manufactured by MARUWA Biochemical Co., Ltd.), a dry flowable containing carfentrazone-ethyl as the active ingredient (tradename: Task DF, manufactured by ISHIHARA SANGYO KAISHA, LTD.) or a water-based suspension containing pyraflufen-ethyl as the active ingredient (tradename: ECOPART flowable, manufactured by NIHON NOHYAKU CO., LTD.), and an emulsifiable concentrate containing S-metolachlor as the active ingredient (tradename: Dual Gold, manufactured by Syngenta) or a wettable powder containing metribuzin as the active ingredient (tradename: SENCOR wettable powder, manufactured by Bayer Crop Science), were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). On the 4th day after spraying, the state of growth of the Italian ryegrass was visually observed, and the growth inhibition rate (%) was obtained in accordance with the evaluation standards described in the above (1) herbicidal effect test, and the results are shown in Table 16. Further, the expected value of the growth inhibition rate (%) was calculated in accordance with the Colby's formula described in the above (1) herbicidal effect test, and the results are also shown in Table 16.

It is found from Table 16 that use of tiafenacil (a1) and S-metolachlor or metribuzin (a2) in combination has improved controlling effects on Italian ryegrass as compared with single use of each ingredient. The growth inhibition rates by use of tiafenacil (a1) and S-metolachlor or metribuzin (a2) in combination, are higher than the expected values, and thus the use in combination is found to have a synergistic effect.

And, the combination of tiafenacil (a1) and S-metolachlor or metribuzin (a2), which is the composition of the present invention, exhibited a growth inhibition rate higher than those of combinations of a test compound other than tiafenacil and S-metolachlor or metribuzin.

Whereas no improvement in the controlling effect on Italian ryegrass by use of the test compound other than tiafenacil, and S-metolachlor or metribuzin in combination, as compared with single use of each compound, was conformed. Further, the growth inhibition rates of such combinations were not higher than the expected values, thus indicating that these combinations do not have a synergistic effect.

TABLE 16

| | | | Growth inhibition |
|---|---|---|---|
| | | | rate (%) |
| | | Dose | Measured value |
| | Test Compound | (g/ha) | (expected value) |
| The | tiafenacil + | 12.5 + 750 | 77(40) |
| present | S-metolachlor | | |
| invention | tiafenacil + | 12.5 + 18.75 | 78(42) |
| | metribuzin | | |
| Compara- | saflufenacil + | 12.5 + 750 | 27(35) |
| tive | S-metolachlor | | |
| | saflufenacil + | 12.5 + 18.75 | 22(38) |
| | metribuzin | | |
| | fomesafen + | 12.5 + 750 | 8(11) |
| | S-metolachlor | | |
| | fomesafen + | 12.5 + 18.75 | 8(14) |
| | metribuzin | | |
| | fluthiacet-methyl + | 12.5 + 750 | 13(15) |
| | S-metolachlor | | |
| | fluthiacet-methyl + | 12.5 + 18.75 | 15(18) |
| | metribuzin | | |
| | carfentrazone-ethyl + | 12.5 + 750 | 12(15) |
| | S-metolachlor | | |
| | carfentrazone-ethyl + | 12.5 + 18.75 | 10(18) |
| | metribuzin | | |
| | pyraflufen-ethyl + | 12.5 + 750 | 28(27) |
| | S-metolachlor | | |
| | pyraflufen-ethyl + | 12.5 + 18.75 | 28(30) |
| | metribuzin | | |
| | tiafenacil | 12.5 | 38 |
| | saflufenacil | 12.5 | 33 |
| | fomesafen | 12.5 | 8 |
| | fluthiacet-methyl | 12.5 | 12 |
| | carfentrazone-ethyl | 12.5 | 12 |
| | pyraflufen-ethyl | 12.5 | 25 |
| | S-metolachlor | 750 | 3 |
| | metribuzin | 18.75 | 7 |

Now, a test on growth promotion effect of the composition of the present invention on useful plants (hereinafter referred to as plant growth promotion effect test) will be described.

First, the plant growth promotion effect test under conditions where undesired plants grow will be described.

### (17) Plant Growth Promotion Effect Test (Corn)

Upland soil was put in a 1/1,000,000 hectare pot, and seeds of Italian ryegrass (Lolium multiflorum) were sown. When the Italian ryegrass reached 2.5 to 3.0 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta) or a wettable powder containing metribuzin as the active ingredient (tradename: SENCOR wettable powder, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of forage corn (cultivar: SNOW DENT OTOHA, manufactured by SNOW BRAND SEED Co., Ltd.) were sown in the pot after spraying. On the 20th day after the sowing, the above-ground part of the forage corn was reaped, and its weight was measured to obtain the raw weight. The results are shown in Table 17.

It is found from Table 17 that use of tiafenacil (a1) and S-metolachlor or metribuzin (a2) in combination increased the raw weight of the forage corn as compared with the non-treated area and single use of each ingredient.

TABLE 17

| | Dose | Raw weight (g) of |
|---|---|---|
| Test Compound | (g/ha) | forage corn |
| tiafenacil + | 12.5 + 750 | 17.1 |
| S-metolachlor | | |
| tiafenacil + | 12.5 + 18.75 | 13.4 |
| metribuzin | | |
| tiafenacil | 12.5 | 8.5 |
| S-metolachlor | 750 | 5.1 |
| metribuzin | 18.75 | 6.2 |
| (Non-treated area) | — | 6.6 |

### (18) Plant Growth Promotion Effect Test (Corn)

Upland soil was put in a 1/1,000,000 hectare pot, and seeds of Italian ryegrass (Lolium multiflorum) were sown. When the Italian ryegrass reached 2.7 to 3.1 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science) or water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of forage corn (cultivar: SNOW DENT OTOHA, manufactured by SNOW BRAND SEED Co., Ltd.) were sown in the pot after spraying. On the 21st day after the sowing, the above-ground part of the forage corn was reaped, and its weight was measured to obtain the raw weight. The results are shown in Table 18.

It is found from Table 18 that use of tiafenacil (a1) and S-metolachlor, metribuzin or pyroxasulfone (a2) in combination increased the raw weight of the forage corn as compared with the non-treated area and single use of each ingredient.

TABLE 18

| | Dose | Raw weight (g) of |
|---|---|---|
| Test Compound | (g/ha) | forage corn |
| tiafenacil + | 6.25 + 750 | 6.9 |
| S-metolachlor | 6.25 + 7.5 | 8.7 |
| tiafenacil + | 6.25 + 550 | 6.7 |
| metribuzin | 6.25 + 225 | 6.6 |
| tiafenacil + | 6.25 + 250 | 8.2 |
| pyroxasulfone | 6.25 + 125 | 6.5 |
| | 6.25 + 7.5 | 9.5 |
| tiafenacil | 6.25 | 3.2 |
| S-metolachlor | 750 | 3.1 |
| | 7.5 | 3.5 |
| metribuzin | 550 | 5.6 |
| | 225 | 4.7 |
| pyroxasulfone | 250 | 3.8 |
| | 125 | 3.3 |
| | 7.5 | 5.8 |
| (Non-treated area) | — | 5.1 |

### (19) Plant Growth Promotion Effect Test (Corn)

Upland soil was put in a 1/1,000,000 hectare pot, and seeds of Italian ryegrass (Lolium multiflorum) were sown. When the Italian ryegrass reached 3.2 to 3.7 leaf stage, a water-based suspension containing tiafenacil as the active ingredient, prepared by a conventional method for preparing a water-based suspension, and a wettable powder containing tri-allate as the active ingredient, prepared by a conventional method for preparing a wettable powder or an emulsifiable concentrate containing pethoxamid as the active ingredient (tradename: Successor 600, manufactured by Stähler Suisse SA) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of forage corn (cultivar: SNOW DENT OTOHA, manufactured by SNOW BRAND SEED Co., Ltd.) were sown in the pot after spraying. On the 21st day after the sowing, the above-ground part of the forage corn was reaped, and its weight was measured to obtain the raw weight. The results are shown in Table 19.

It is found from Table 19 that use of tiafenacil (a1) and tri-allate or pethoxamid (a2) in combination increased the raw weight of the forage corn as compared with the non-treated area and single use of each ingredient.

TABLE 19

| | Dose | Raw weight (g) of |
|---|---|---|
| Test Compound | (g/ha) | forage corn |
| tiafenacil + | 6.25 + 1250 | 5.8 |
| tri-allate | 6.25 + 625 | 5.3 |
| | 6.25 + 75 | 5.7 |
| tiafenacil + | 6.25 + 750 | 4.4 |
| pethoxamid | 6.25 + 375 | 5.2 |
| | 6.25 + 93.8 | 6.0 |
| tiafenacil | 6.25 | 3.9 |
| tri-allate | 1250 | 2.5 |
| | 625 | 2.2 |
| | 75 | 2.6 |
| pethoxamid | 750 | 3.6 |
| | 375 | 2.2 |
| | 93.8 | 3.4 |
| (Non-treated area) | — | 2.3 |

### (20) Plant Growth Promotion Effect Test (Corn)

Upland soil was put in a 1/1,000,000 hectare pot, and seeds of Italian ryegrass (Lolium multiflorum) were sown. When the Italian ryegrass reached 2.7 to 3.0 leaf stage, a water-based suspension containing tiafenacil as the active ingredient, prepared by a conventional method for preparing a water-based suspension, and an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of forage corn (cultivar: SNOW DENT OTOHA, manufactured by SNOW BRAND SEED Co., Ltd.) were sown in the pot after spraying. On the 33rd day after the sowing, the above-ground part of the forage corn was reaped, and its weight was measured to obtain the raw weight. The results are shown in Table 20.

It is found from Table 20 that use of tiafenacil (a1) and dimethenamid-P (a2) in combination increased the raw weight of the forage corn as compared with the non-treated area and single use of each ingredient.

TABLE 20

| | Dose | Raw weight (g) of |
|---|---|---|
| Test Compound | (g/ha) | forage corn |
| tiafenacil + | 6.25 + 750 | 19.0 |
| dimethenamid-P | 6.25 + 375 | 21.9 |
| | 6.25 + 60 | 15.5 |
| tiafenacil | 6.25 | 12.1 |
| dimethenamid-P | 750 | 8.0 |
| | 375 | 12.5 |
| | 60 | 9.8 |
| (Non-treated area) | — | 2.7 |

### (21) Plant Growth Promotion Effect Test (Wheat)

Upland soil was put in a 1/1,000,000 hectare pot, and seeds of Italian ryegrass (Lolium multiflorum) were sown. When the Italian ryegrass reached 3.3 to 3.8 leaf stage, a water-based suspension containing tiafenacil as the active ingredient, prepared by a conventional method for preparing a water-based suspension, and a wettable powder containing metribuzin as the active ingredient (tradename: SENCOR wettable powder, manufactured by Bayer Crop Science) or water dispersible granules containing pyroxasulfone as the active ingredient (tradename: Sakura, manufactured by Bayer Crop Science) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of wheat (cultivar: Norin 61, manufactured by Asahi Noen Seed Co., Ltd.) were sown in the pot after spraying. On the 22nd day after the sowing, the above-ground part of the wheat was reaped, and its weight was measured to obtain the raw weight. The results are shown in Table 21.

It is found from Table 21 that use of tiafenacil (a1) and metribuzin or pyroxasulfone (a2) in combination increased the raw weight of the wheat as compared with the non-treated area and single use of each ingredient.

TABLE 21

| | Dose | Raw weight (g) |
|---|---|---|
| Test Compound | (g/ha) | of wheat |
| tiafenacil + | 3 + 150 | 4.5 |
| metribuzin | | |
| tiafenacil + | 3 + 37.5 | 4.0 |
| pyroxasulfone | | |
| tiafenacil | 3 | 2.3 |
| metribuzin | 150 | 2.5 |
| pyroxasulfone | 37.5 | 1.2 |
| (Non-treated area) | — | 1.2 |

### (22) Plant Growth Promotion Effect Test (Wheat)

Upland soil was put in a 1/1,000,000 hectare pot, and seeds of Italian ryegrass (Lolium multiflorum) were sown. When the Italian ryegrass reached 2.5 to 2.8 leaf stage, a water-based suspension containing tiafenacil as the active ingredient, prepared by a conventional method for preparing a water-based suspension, and a wettable powder containing tri-allate as the active ingredient, prepared by a conventional method for preparing a wettable powder, were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of wheat (cultivar: Norin 61, manufactured by Asahi Noen Seed Co., Ltd.) were sown in the pot after spraying. On the 21st day after the sowing, the above-ground part of the wheat was reaped, and its weight was measured to obtain the raw weight. The results are shown in Table 22.

It is found from Table 22 that use of tiafenacil (a1) and tri-allate (a2) in combination increased the raw weight of the wheat as compared with the non-treated area and single use of each ingredient.

TABLE 22

| | Dose | Raw weight (g) |
|---|---|---|
| Test Compound | (g/ha) | of wheat |
| tiafenacil + | 3 + 200 | 2.7 |
| tri-allate | | |
| tiafenacil | 3 | 2.2 |
| tri-allate | 200 | 2.3 |
| (Non-treated area) | — | 2.3 |

### (23) Plant Growth Promotion Effect Test (Soybean)

Upland soil was put in a 1/200,000 hectare pot, and seeds of Italian ryegrass (Lolium multiflorum) were sown. When the Italian ryegrass reached 2.5 to 3.0 leaf stage, a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science), water dispersible granules containing pyroxasulfone as the active ingredient (tradename: Sakura, manufactured by Bayer Crop Science), a wettable powder containing tri-allate as the active ingredient, prepared by a conventional method for preparing a wettable powder, an emulsifiable concentrate containing pethoxamid as the active ingredient (tradename: Successor 600, manufactured by Stähler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of soybean (cultivar: Enrei, manufactured by Asahi Noen Seed Co., Ltd.) were sown in the pot after spraying and the soybean was cultivated. On the 97th day after the sowing, seeds were collected from the grown soybean, and their weight was measured to obtain the total weight. The results are shown in Table 23.

It is found from Table 23 that use of tiafenacil (a1) and S-metolachlor, metribuzin, pyroxasulfone, tri-allate, pethoxamid or dimethenamid-P (a2) in combination increased the total weight of the soybean seeds as compared with the non-treated area and single use of each ingredient.

TABLE 23

| | Dose | Total weight (g) of |
|---|---|---|
| Test Compound | (g/ha) | soybean seeds |
| tiafenacil + | 12.5 + 750 | 34.5 |
| S-metolachlor | | |
| tiafenacil + | 12.5 + 18.75 | 22.5 |
| metribuzin | | |
| tiafenacil + | 12.5 + 125 | 43.4 |
| pyroxasulfone | | |
| tiafenacil + | 12.5 + 625 | 45.2 |
| tri-allate | | |
| tiafenacil + | 12.5 + 750 | 45.2 |
| pethoxamid | | |
| tiafenacil + | 12.5 + 750 | 50.0 |
| dimethenamid-P | | |
| tiafenacil | 12.5 | 14.3 |
| S-metolachlor | 750 | 12.7 |
| metribuzin | 18.75 | 14.2 |
| pyroxasulfone | 125 | 15.6 |
| tri-allate | 625 | 17.0 |
| pethoxamid | 750 | 11.0 |
| dimethenamid-P | 750 | 14.1 |
| (Non-treated area) | — | 11.0 |

From the above results of the plant growth promotion effect tests (17) to (23), the growth promotion effects of the composition of the present invention on the useful plants were confirmed. The plant growth promotion effect tests (17) to (23) were conducted under conditions where seeds of undesired plants were sown, and thus by control of the undesired plants by the composition of the present invention, interference by the undesired plants with the useful plants was reduced, which is considered to be at least one factor in the growth promotion effects of the composition of the present invention on the useful plants. Thus, now, a test on plant growth promotion effect of the composition of the present invention on useful plants, conducted under conditions where seeds of undesired plants were not sown, will be described.

### (24) Plant Growth Promotion Effect Test (Soybean)

Upland soil was put in a 1/500,000 hectare pot, and a water-based suspension containing tiafenacil as the active ingredient, prepared by a conventional method for preparing a water-based suspension, and an emulsifiable concentrate containing S-metolachlor as the active ingredient (tradename: Dual Gold, manufactured by Syngenta), a wettable powder containing metribuzin as the active ingredient (tradename: SENCOR wettable powder, manufactured by Bayer Crop Science), water dispersible granules containing pyroxasulfone as the active ingredient (tradename: Sakura, manufactured by Bayer Crop Science), a wettable powder containing tri-allate as the active ingredient, prepared by a conventional method for preparing a wettable powder, an emulsifiable concentrate containing pethoxamid as the active ingredient (tradename: Successor 600, manufactured by Stähler Suisse SA) or an emulsifiable concentrate containing dimethenamid-P as the active ingredient (tradename: Fieldstar P emulsifiable concentrate, manufactured by BASF) were diluted with water (in an amount corresponding to 200 liter per hectare) containing 0.5 vol % of an agricultural spreader (tradename: Destiny HC, manufactured by Winfield Solutions, LLC.) and sprayed by a small spray gun (model: W-101-132G, manufactured by ANEST IWATA Corporation). Seeds of soybean (cultivar: Enrei, manufactured by Asahi Noen Seed Co., Ltd.) were sown in the pot after spraying. On the 48th day after the sowing, the above-ground part of the soybean was reaped, and its weight was measured to obtain the total weight. The results are shown in Table 24.

It is found from Table 24 that use of tiafenacil (a1) and S-metolachlor, metribuzin, pyroxasulfone, tri-allate, pethoxamid or dimethenamid-P (a2) in combination increased the raw weight of the soybean as compared with the non-treated area and single use of each ingredient. Thus, it is confirmed that the composition of the present invention has growth promotion effects on soybean, under conditions where undesired plants are not sown.

TABLE 24

| | Dose | Raw weight (g) of |
|---|---|---|
| Test Compound | (g/ha) | soybean |
| tiafenacil + | 3 + 75 | 47.7 |
| S-metolachlor | | |
| tiafenacil + | 3 + 150 | 53.5 |
| metribuzin | | |
| tiafenacil + | 3 + 37.5 | 40.0 |
| pyroxasulfone | | |
| tiafenacil + | 3 + 200 | 53.8 |
| tri-allate | | |
| tiafenacil + | 3 + 200 | 38.5 |
| pethoxamid | | |
| tiafenacil + | 3 + 150 | 38.0 |
| dimethenamid-P | | |
| tiafenacil | 3 | 28.3 |
| S-metolachlor | 75 | 27.1 |
| metribuzin | 150 | 16.1 |
| pyroxasulfone | 37.5 | 30.0 |
| tri-allate | 200 | 18.2 |
| pethoxamid | 200 | 26.7 |
| dimethenamid-P | 150 | 28.9 |
| (Non-treated area) | — | 23.2 |

It was found from the results of the above herbicidal effect tests and the plant growth promotion effect tests that the composition of the present invention has effects to control undesired plants and effects to promote growth of useful plants.

The entire disclosure of Japanese Patent Application No. 2022-121363 filed on Jul. 29, 2022, including specification, claims and abstract is incorporated herein by reference in its entirety.

1. A method for controlling undesired plants and promoting growth of useful plants, which comprises applying an effective amount of tiafenacil (a1) and an effective amount of at least one herbicidal compound (a2) selected from the following compound group A, to the undesired plants, to a place where the undesired plants grow, or to a place where the useful plants are cultivated;
compound group A: herbicidal compounds S-metolachlor, metribuzin, pyroxasulfone, pethoxamid, tri-allate and dimethenamid-P.

2. The method according to claim 1, wherein the herbicidal compound (a2) is at least one member selected from S-metolachlor and metribuzin.

3. The method according to claim 1, wherein the herbicidal compound (a2) is S-metolachlor.

4. The method according to claim 1, wherein the mixing weight ratio of (a1) to (a2) is from 1:0.8 to 1:1000.

5. The method according to claim 1, wherein the mixing weight ratio of (a1) to (a2) is from 1:1.2 to 1:200.

6. The method according to claim 1, wherein (a1) is applied at a dose of from 0.01 to 400 g/ha, and (a2) is applied at a dose of from 0.1 to 5000 g/ha.

7. The method according to claim 1, wherein (a1) is applied at a dose of from 0.05 to 300 g/ha, and (a2) is applied at a dose of from 1 to 4000 g/ha.

8. An agricultural composition comprising as active ingredients tiafenacil (a1) and at least one herbicidal compound (a2) selected from the following compound group A, in a mixing weight ratio of (a1) to (a2) of from 1:0.8 to 1:1000;
compound group A: herbicidal compounds S-metolachlor, metribuzin, pyroxasulfone, pethoxamid, tri-allate and dimethenamid-P.

9. The agricultural composition according to claim 8, wherein the mixing weight ratio of (a1) to (a2) is from 1:1.2 to 1:200.

10. A combination of tiafenacil (a1) and at least one herbicidal compound (a2) selected from the following compound group A as active ingredients, in a mixing weight ratio of (a1) to (a2) of from 1:0.8 to 1:1000; compound group A: herbicidal compounds S-metolachlor, metribuzin, pyroxasulfone, pethoxamid, tri-allate and dimethenamid-P.

11. The method according to claim 2, wherein the mixing weight ratio of (a1) to (a2) is from 1:0.8 to 1:1000.

12. The method according to claim 2, wherein the mixing weight ratio of (a1) to (a2) is from 1:1.2 to 1:200.

13. The method according to claim 2, wherein (a1) is applied at a dose of from 0.01 to 400 g/ha, and (a2) is applied at a dose of from 0.1 to 5000 g/ha.

14. The method according to claim 2, wherein (a1) is applied at a dose of from 0.05 to 300 g/ha, and (a2) is applied at a dose of from 1 to 4000 g/ha.

15. The method according to claim 3, wherein the mixing weight ratio of (a1) to (a2) is from 1:0.8 to 1:1000.

16. The method according to claim 3, wherein the mixing weight ratio of (a1) to (a2) is from 1:1.2 to 1:200.

17. The method according to claim 3, wherein (a1) is applied at a dose of from 0.01 to 400 g/ha, and (a2) is applied at a dose of from 0.1 to 5000 g/ha.

18. The method according to claim 3, wherein (a1) is applied at a dose of from 0.05 to 300 g/ha, and (a2) is applied at a dose of from 1 to 4000 g/ha.
